(19) United States
(12) Patent Application Publication
(10) Pub. No.: US 2026/0369868 A1
(43) Pub. Date: Nov. 19, 2026

(54) BASE STATION ANTENNAS HAVING FREQUENCY SELECTIVE SURFACES WITH UNIT CELLS COMPRISING INDUCTOR FEATURES

(71) Applicant: Outdoor Wireless Networks LLC, Richardson, TX (US)

(72) Inventors: Haifeng Li, Allen, TX (US); Peter J. Bisiules, LaGrange Park, IL (US)

(21) Appl. No.: 19/133,783

(22) PCT Filed: Sep. 22, 2023
(86) PCT No.: PCT/US2023/074896

§ 371 Date: May 29, 2025

Related U.S. Application Data
(60) Provisional application No. 63/385,670, filed on Dec. 1, 2022.

(51) Int. Cl. H01Q 1/24; H01Q 3/36; H01Q 5/30; H01Q 15/00; H01Q 21/06

(52) U.S. Cl. CPC H01Q 1/246; H01Q 3/36; H01Q 5/30; H01Q 15/002; H01Q 15/0026; H01Q 21/062

(57) ABSTRACT

Base station antennas include at least two frequency selective surfaces/layers with an array of low band radiating elements projecting forward of a front one of the FSS layers. The FSS layers are provided with unit cells having inductor features and may be provided as two stacked layers each with unit cells having aligned inductor features with different inductor values providing improved reflectivity and super wideband performance. An antenna array resides behind a back one of the at least two FSS layers and is configured to transmit signal through the at least two FSS layers and out a front radome of the base station antenna.

### RELATED APPLICATIONS

This patent application claims the benefit of and priority to U.S. Provisional Application Ser. No. 63/385,670, filed Dec. 1, 2022, the contents of which are hereby incorporated by reference as if recited in full herein.

### BACKGROUND

The present invention generally relates to radio communications and, more particularly, to base station antennas for cellular communications systems.

Cellular communications systems are well known in the art. In a cellular communications system, a geographic area is divided into a series of regions that are referred to as “cells” which are served by respective base stations. The base station may include one or more antennas that are configured to provide two-way radio frequency (“RF”) communications with mobile subscribers that are within the cell served by the base station. In many cases, each cell is divided into “sectors.” In one common configuration, a hexagonally shaped cell is divided into three 120° sectors in the azimuth plane, and each sector is served by one or more base station antennas that have an azimuth Half Power Beamwidth (HPBW) of approximately 65°. Typically, the base station antennas are mounted on a tower or other raised structure, with the radiation patterns (also referred to herein as “antenna beams”) that are generated by the base station antennas directed outwardly. Base station antennas are often implemented as linear or planar phased arrays of radiating elements.

In order to accommodate the increasing volume of cellular communications, cellular operators have added cellular service in a variety of new frequency bands. In order to increase capacity without further increasing the number of base station antennas, multi-band base station antennas have been introduced which include multiple linear arrays of radiating elements. Additionally, base station antennas are now being deployed that include “beamforming” arrays of radiating elements that include multiple columns of radiating elements. The radios for these beamforming arrays may be integrated into the antenna so that the antenna may perform active beamforming (i.e., the shapes of the antenna beams generated by the antenna may be adaptively changed to improve the performance of the antenna). These beamforming arrays typically operate in higher frequency bands, such as various portions of the 3.3-5.8 GHz frequency band. Antennas having integrated radios that can adjust the amplitude and/or phase of the sub-components of an RF signal that are transmitted through individual radiating elements or small groups thereof are referred to as “active antennas.” Active antennas can generate narrowed beamwidth, high gain, antenna beams and can steer the generated antenna beams in different directions by changing the amplitudes and/or phases of the sub-components of RF signals that are transmitted through the antenna.

With the development of wireless communication technology, an integrated base station antenna including a passive module and an active antenna module with an active antenna has emerged. The passive module may include one or more passive arrays of radiating elements that are configured to generate relatively static antenna beams, such as antenna beams that are configured to cover a 120 degree sector (in the azimuth plane) of a base station antenna. The passive arrays may comprise arrays that operate under second generation (2G), third generation (3G) or fourth generation (4G) cellular standards. These passive arrays are not configured to perform active beamforming operations, although they typically have remote electronic tilt (RET) capabilities which allows the shape of the antenna beam to be changed via electromechanical means in order to change the coverage area of the antenna beam. The active antenna module may include one or more arrays of radiating elements that operate under fifth generation (or later) cellular standards. These arrays typically have individual amplitude and phase control over subsets of the radiating elements therein and perform active beamforming.

FIG. 1 illustrates an example of a prior art base station antenna 10 that includes a pair of beamforming arrays and associated beamforming radios. The base station antenna 10 is typically mounted with the longitudinal axis L of the antenna 10 extending along a vertical axis (e.g., the longitudinal axis L may be generally perpendicular to a plane defined by the horizon) when the antenna 10 is mounted for normal operation. The front surface of the antenna 10 is mounted opposite the tower or other mounting structure, pointing toward the coverage area for the antenna 10. The antenna 10 includes a radome 11 and a top end cap 20. The antenna 10 also includes a bottom end cap 30 which includes a plurality of connectors 40 mounted therein. As shown, the radome 11, top cap 20 and bottom cap 30 define an external housing 10h for the antenna 10. An antenna assembly is contained within the housing 10h.

The antenna 10 can include one or more radios that are mounted to the rear of the housing 10h. Heat generated in the radio(s) typically passes to a heat sink and spreads to the fins thereof (not shown). Further details of example conventional base station antennas can be found in co-pending WO2019/236203 and WO2020/072880, the contents of which are hereby incorporated by reference as if recited in full herein.

### SUMMARY

Embodiments of the present invention are directed to base station antennas with one or more frequency selective surface (FSS) layers configured with unit cells having inductor features to allow high band radiating elements to propagate electromagnetic waves through the apertures and reflect lower band signal from lower band radiating elements in front of the one or more FSS layers.

Aspects of the invention are directed to a base station antenna that includes: a first frequency selective surface (FSS) having a first array of unit cells and a second FSS having a second array of unit cells. The first FSS is stacked in front of the second FSS in the base station antenna in a Z direction. Each unit cell of the first array of unit cells and each unit cell of the second array of unit cells include a plurality of spaced apart inductor structures, and a first unit cell of the first array of unit cells is aligned in an X-Y direction with a first unit cell of the second array of unit cells whereby respective inductor structures of the first unit cell are aligned with respective inductor structures of the first unit cell of the second array of unit cells.

The first unit cell of the first array of unit cells can have a perimeter with first and second neighboring unit cells sharing a perimeter side and the inductor structures of the first and second neighboring unit cells can be electrically connected.

The inductor structures of the first unit cell of the first array and the first unit cell of the second array can be provided as curvilinear projections that reside on or adjacent an outer perimeter of a respective first unit cell.

The first unit cell of the first and second arrays of unit cells can each have a center and four linear segments that project outwardly from the center. The four linear segments can be orthogonal to each other, and the four linear segments can each merge into at least one inductor structure of respective inductor structures thereof.

The respective inductor structures of each unit cell can have projections that serially project outwardly from opposing sides of a laterally or longitudinally center line of a corresponding linear segment. The projections of the inductor structures of the first unit cell of the second array can extend outside a boundary of the projections of the first unit cell of the first array of unit cells.

Inductor structures of neighboring unit cells of the first array of unit cells can define a parallel inductor circuit.

One inductor structure of a first unit cell of the first array of unit cells can merge into one inductor structure of a neighboring second unit cell of the first array of unit cells at a shared perimeter side.

The inductor structures can reside only on a perimeter of a respective unit cell of the first array of unit cells and the second array of unit cells.

The first unit cell of the first and second arrays of unit cells can further include a curvilinear segment that surrounds the center. The four linear segments can extend from four sides of the curvilinear segment that surrounds the center.

The four linear segments can be inner linear segments and the first unit cell can further include four outer linear segments. One inductor structure of the inductor structures can reside between a pair of outer and inner linear segments.

The base station antenna can further include a third FSS with a third array of unit cells residing behind the second FSS.

The base station antenna can further include a passive antenna in a housing with the first FSS and the second FSS, and an active antenna unit residing behind the housing.

The base station antenna can further include a first plurality of radiating elements residing in front of the first FSS and a second plurality of radiating elements residing behind the second FSS.

The first plurality of radiating elements can operate in a first frequency band and the second plurality of radiating elements can operate in a second frequency band.

The first plurality of radiating elements can have low band radiating elements that are configured to operate in a first frequency band and the second plurality of radiating elements can have higher band radiating elements that are configured to operate in a second frequency band, the second frequency band encompassing higher frequencies than the first frequency band.

The first FSS and the second FSS can be configured to allow RF energy in the second frequency band to propagate therethrough.

The first FSS can have a first subset of the first array of unit cells configured for blocking and/or reflecting RF energy in a first frequency band while allowing RF energy in a second frequency band to propagate therethrough. The first FSS can also have a second subset of the first array of unit cells configured for blocking and/or reflecting RF energy in the first frequency band and RF energy in a third frequency band. The third frequency band has frequencies between the first and second frequency bands.

The first subset of the first array of unit cells can be positioned at an upper portion of the base station antenna. The second subset of the first array of unit cells can have unit cells that are to the right side of the first subset of the unit cells and can also have unit cells that are to the left side of the first subset of the unit cells.

The first plurality of radiating elements can have high band radiating elements that operate in at least part of a 3.2-4.1 GHz frequency band, and the second plurality of radiating elements can have radiating elements that operate in at least part of a lower frequency band that the high band radiating elements.

The first FSS and the second FSS can be configured to allow RF energy in at least part of a 3.2-4.1 GHz frequency band to propagate therethrough.

The second plurality of radiating elements can be provided as a multiple column array in an active antenna module.

At least some unit cells of the first array of unit cells and/or the second array of unit cells can include at least one transmission line (TX) segment configured to electrically couple to at least one inductor structure.

A length of the at least one TX line segment can be configured so that radiofrequency signals from radiating elements traversing the at least one TX line segment undergo a 180 degree phase shift at a defined frequency.

A length of the at least one TX line segment can be about a half wavelength of a defined frequency response point. Optionally, the defined frequency can be a second frequency response point f2 such that the unit cells define a dual response band.

Some aspects of the present invention are directed to a base station antenna that includes: a first frequency selective surface (FSS) comprising a first array of unit cells; and a second FSS comprising a second array of unit cells. The first FSS is stacked in front of the second FSS in the base station antenna in a Z direction. At least some unit cells of the first array of unit cells and the second array of unit cells are configured to provide an equivalent circuit comprising at least one inductor and at least one transmission line (TX) segment configured to electrically couple to at least one inductor.

A length of the at least one TX line segment can be configured so that radiofrequency signals from radiating elements traversing the at least one TX line segment undergo a 180 degree phase shift at a defined frequency.

A length of the at least one TX line segment can be about a half wavelength of a defined frequency response point.

A unit cell provided by the first array and a unit cell provided by the second array can be electrically coupled.

A first unit cell of the first array of unit cells can be electrically coupled to a first unit cell of the second array of unit cells whereby the first unit cells cooperate to define an equivalent circuit to reject or block radiofrequency signals from radiating elements in a first frequency band and pass signals from radiating elements operating in a second frequency band.

Yet other embodiments are directed to a grid reflector for a base station antenna that includes a frequency selective surface (FSS) comprising an array of unit cells. At least some unit cells of the array of unit cells have at least one transmission line (TX) segment.

The at least one TX line segment has a length that is about a half wavelength of a defined frequency.

The at least one TX line segment can be configured so that radiofrequency signals from radiating elements traversing the at least one TX line segment undergo a 180-phase shift at a defined frequency.

At least some of the unit cells with the at least one transmission line segment reject radiofrequency signals in a first frequency band and in a second greater frequency band corresponding to the defined frequency.

The at least one TX line segment can comprise adjacent parallel conductive lines.

Still other embodiments are directed to a grid reflector for a base station antenna that includes a frequency selective surface (FSS) comprising a first array of unit cells having a first configuration and a second array of cells having a second configuration. The first array includes unit cells having a square shape and the second array includes unit cells having a hexagonal shape. The first array extends medially across 30-80 percent of a width of the FSS and the second array is provided in two columns on right and left side portions of the first array.

At least some unit cells of the array of unit cells can include at least one transmission line (TX) segment having a length configured so that radiofrequency signals from radiating elements traversing the at least one TX line segment undergo a 180-degree phase shift at a defined frequency.

The FSS can be configured to have a response frequency f0 that is about 2.5GHz and can provide a bandpass frequency range and a bandstop frequency range.

The at least one TX line segment can have a length L that is about half wavelength of a defined frequency response point.

The base station antenna can include a passive module and/or a passive antenna assembly and an active antenna module, the active antenna module can be installed at a position corresponding to the frequency selective surface.

According to embodiments of the present disclosure, the frequency selective surface is provided as first and second frequency selective surfaces, stacked one if front of the other, and can be configured to allow electromagnetic waves emitted by the active module to pass.

It should be noted that various aspects of the present disclosure described for one embodiment may be included in other different embodiments, even though specific description is not made for the other different embodiments. In other words, all the embodiments and/or features of any embodiment may be combined in any manner and/or combination, as long as they are not contradictory to each other.

### BRIEF DESCRIPTION OF THE DRAWINGS

FIG. 1 is a perspective view of a prior art base station antenna.

FIG. 2A is a back perspective view of an example base station antenna coupled to an active antenna module according to embodiments of the present invention.

FIG. 2B is a side, back perspective view of another example base station antenna coupled to an active antenna module according to embodiments of the present invention.

FIG. 3 is a perspective view of an example primary reflector that can be provided in a base station antenna, such as the base station antenna shown in FIG. 2A or FIG. 2B, according to embodiments of the present invention.

FIG. 4A is a perspective view of a grid reflector for a base station antenna according to embodiments of the present invention.

FIG. 4B is a front view of the grid reflector shown in FIG. 4A.

FIG. 5 is a greatly enlarged unit cell of a grid reflector for a base station antenna according to embodiments of the present invention.

FIG. 6 is a schematic top view of first and second FSS layers stacked in a front to back (Z) direction, each having unit cells with inductor features of the respective FSS according to embodiments of the present invention.

FIG. 7 is a schematic top view of first, second and third FSS layers stacked in a front to back (Z) direction, each having unit cells with inductor features of the respective FSS according to embodiments of the present invention.

FIG. 8 is a greatly enlarged front view of the first and second FSS layers shown in FIG. 6 with aligned unit cells (aligned in the X, Y directions) according to embodiments of the present invention.

FIG. 9 is a greatly enlarged front view of neighboring unit cells of the first and second FSS layers shown in FIG. 8 according to embodiments of the present invention.

FIG. 10A is a greatly enlarged front view of another embodiment of a unit cell with inductor features according to embodiments of the present invention.

FIG. 10B is a greatly enlarged front view of another embodiment of a unit cell with inductor features, similar to FIG. 10A, according to embodiments of the present invention.

FIG. 10C is an example wideband FSS equivalent circuit provided by unit cells of FIG. 10B and/o FIG. 10C according to embodiments of the present invention.

FIG. 11 is a greatly enlarged front view of yet another embodiment of a unit cell with inductor features according to embodiments of the present invention.

FIG. 12 is a greatly enlarged front view of an additional embodiment of a unit cell with inductor features according to embodiments of the present invention.

FIG. 13 is a greatly enlarged view of neighboring unit cells of the configuration shown in FIG. 12 according to embodiments of the present invention.

FIG. 14 is a schematic illustration of two adjacent, neighboring unit cells illustrating centers a, b of respective neighboring unit cells and example current flow according to embodiments of the present invention.

FIG. 15 is a schematic illustration of a unit cell of an FSS layer illustrating example radiation direction according to embodiments of the present invention.

FIG. 16A is an example equivalent circuit provided by the unit cell features of embodiments of the present invention.

FIG. 16B is an example equivalent circuit provided by the unit cell features of embodiments of the present invention.

FIG. 16C is a graph of a simulated response (dB) versus frequency (GHz) for an example wideband FSS with horizontal and vertical equivalent circuits provided by unit cells with the horizontal and vertical equivalent circuits of FIGS. 16A and 16B according to embodiments of the present invention.

FIG. 16D is a graph of a simulated response versus frequency (GHz) for an example wideband FSS with equivalent circuits provided by unit cells with the equivalent circuit of FIG. 16B according to embodiments of the present invention.

FIG. 17A is another example equivalent circuit provided by the unit cell features with a transmission line segment in parallel with the parallel LC shown in FIG. 16B according to embodiments of the present invention.

FIG. 17B is graph of a simulated response (dB) versus frequency (GHz) (with f0 and f2) with a baseline response for the equivalent circuit shown in FIG. 17A.

FIG. 18A is another example equivalent circuit provided by the unit cell features with two TX line segments in parallel with the parallel LC shown in FIG. 16B providing a 180 degree f2 according to embodiments of the present invention.

FIG. 18B is graph of a simulated response (dB) versus frequency (GHz) (with f0 and f2) for the equivalent circuit shown in FIG. 18A.

FIG. 19A is another example equivalent circuit provided by the unit cell features according to embodiments of the present invention.

FIG. 19B is a front view of an enlarged portion of an FSS showing an example configuration of a unit cell with the equivalent circuit shown in FIG. 19A according to embodiments of the present invention.

FIG. 19C is graph of a simulated response (dB) versus frequency (GHz) (with f0 and f2) for an example equivalent circuit shown in FIG. 19A.

FIG. 20A is another example equivalent circuit provided by the unit cell features according to embodiments of the present invention.

FIG. 20B is a front view of an enlarged portion of an FSS showing an example configuration of a unit cell with the equivalent circuit shown in FIG. 20A according to embodiments of the present invention.

FIG. 20C is graph of a simulated response (dB) versus frequency (GHz) (with f0 and f2) having the equivalent circuit shown in FIG. 20A.

FIG. 21A is another example equivalent circuit provided by the unit cell features according to embodiments of the present invention.

FIG. 21B is a front view of an enlarged portion of an FSS showing an example configuration of a unit cell with the equivalent circuit shown in FIG. 21A according to embodiments of the present invention.

FIG. 21C is a greatly enlarged front view of one portion of the circuit feature in FIG. 21B showing the parallel lines.

FIG. 21D is graph of a simulated response (dB) versus frequency (GHz) (with f0 and f2) for an example equivalent circuit shown in FIG. 21A.

FIG. 22A is another example equivalent circuit provided by the unit cell features according to embodiments of the present invention.

FIG. 22B is a front view of an enlarged portion of a double layer FSS showing an example configuration of the unit cells with the equivalent circuit shown in FIG. 22A according to embodiments of the present invention.

FIG. 22C is graph of a simulated response (dB) versus frequency (GHz) (with single resonance f0) for an example equivalent circuit shown in FIG. 22A.

FIG. 23A is another example equivalent circuit provided by the unit cell features according to embodiments of the present invention.

FIG. 23B is a front view of an enlarged portion of a double layer FSS showing example configurations of the unit cells with the equivalent circuit shown in FIG. 23A according to embodiments of the present invention.

FIG. 23C is graph of a simulated response (dB) versus frequency (GHz) (with double resonance f0, f2) for an example equivalent circuit shown in FIG. 22A.

FIG. 24A is an end view of a portion of an example multiple layer wideband frequency selective surface configuration (z direction facing upward) according to embodiments of the present invention.

FIG. 24B is a front view (x-y directions) of a portion of one layer of the multiple layer wideband frequency selective surface configuration shown in FIG. 24A.

FIG. 25A is an example equivalent circuit configuration of a double layer wideband frequency selective surface according to embodiments of the present invention.

FIG. 25B is a front view of a meta material providing unit cells corresponding to the equivalent circuit shown in FIG. 25A and optionally using a cutout area of primary material that can functionally act as a large capacitor and the equivalent circuit can provide the series LC according to embodiments of the present invention.

FIG. 25C illustrates a front view (x-y direction) of a dielectric material providing the equivalent circuit shown in FIG. 25A according to embodiments of the present invention.

FIGS. 26 and 27 are front views of additional embodiments of the frequency selective surface according to embodiments of the present invention.

FIG. 28 is a front view of yet another embodiment of the frequency selective surface showing different shaped unit cells in different areas of the reflector according to embodiments of the present invention.

FIG. 29A is an enlarged view of a single solid hexagonal patch that can be used for the hexagonal unit cells shown in FIG. 28 according to embodiments of the present invention.

FIG. 29B is an enlarged view of a single hexagonal shaped unit cell that is a hexagonal perimeter or loop surrounding an open area or an area of a different material from the loop that can be used for the hexagonal unit cells shown in FIG. 28 according to embodiments of the present invention.

FIG. 30A is a front, side perspective view of an antenna assembly and example grid reflector of a base station antenna according to embodiments of the present invention.

FIG. 30B is an enlarged front, side perspective view of a top portion of the antenna assembly and grid reflector shown in FIG. 30A.

FIGS. 31A and 31B are simplified lateral section views of example base station antennas and cooperating active antenna modules according to embodiments of the present invention.

FIGS. 32A-32G are front, side, partially transparent views of portions of a base station antenna showing examples of stacked reflector configurations according to embodiments of the present invention.

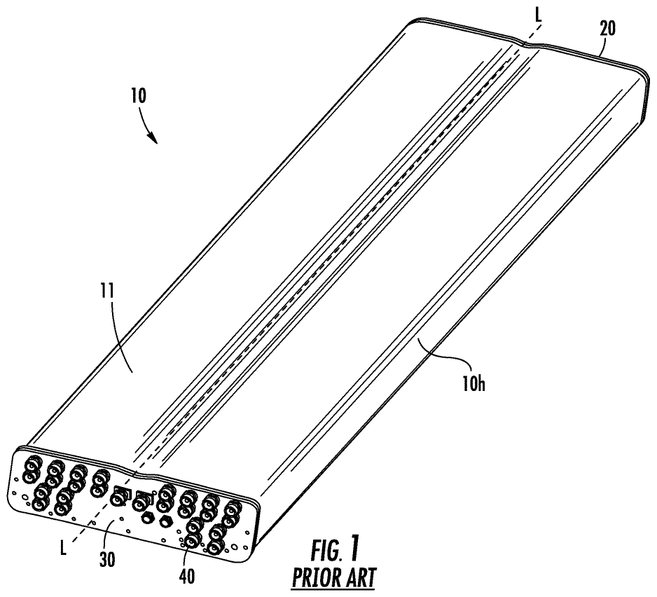

### DETAILED DESCRIPTION

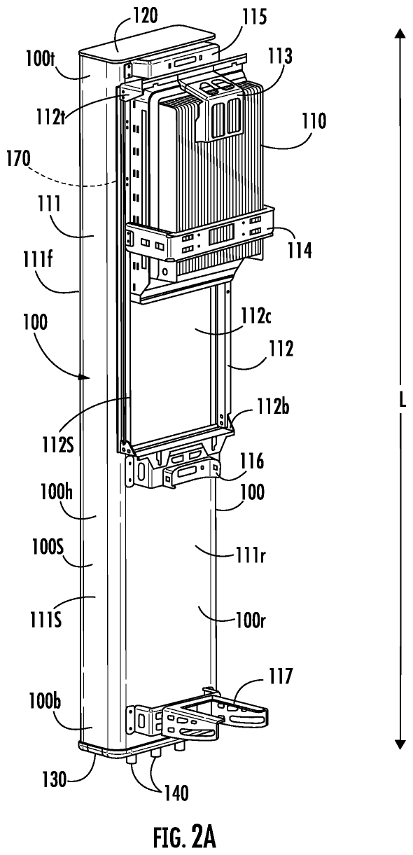

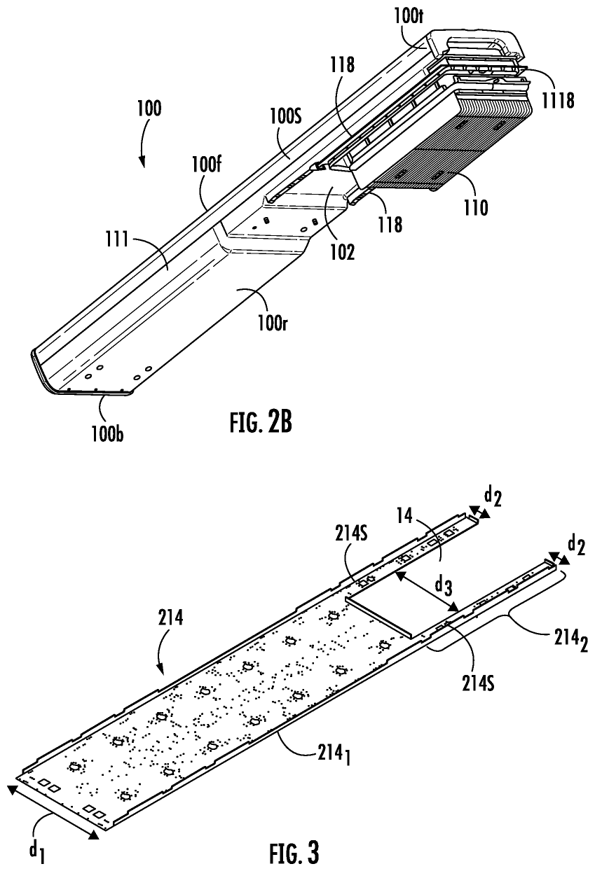

FIG. 2A illustrates a base station antenna 100 according to certain embodiments of the present invention. In the description that follows, the base station antenna 100 will be described using terms that assume that the base station antenna 100 is mounted for use on a tower, pole or other mounting structure with the longitudinal axis L of the base station antenna 100 extending along a vertical axis and the front of the base station antenna 100 mounted opposite the tower, pole or other mounting structure pointing toward the target coverage area for the base station antenna 100 and the rear 100r of the base station antenna 100 facing the tower or other mounting structure. It will be appreciated that the base station antenna 100 may not always be mounted so that the longitudinal axis L thereof extends along a vertical axis. For example, the base station antenna 100 may be tilted slightly (e.g., less than 10°) with respect to the vertical axis so that the resultant antenna beams formed by the base station antenna 100 each have a small mechanical downtilt.

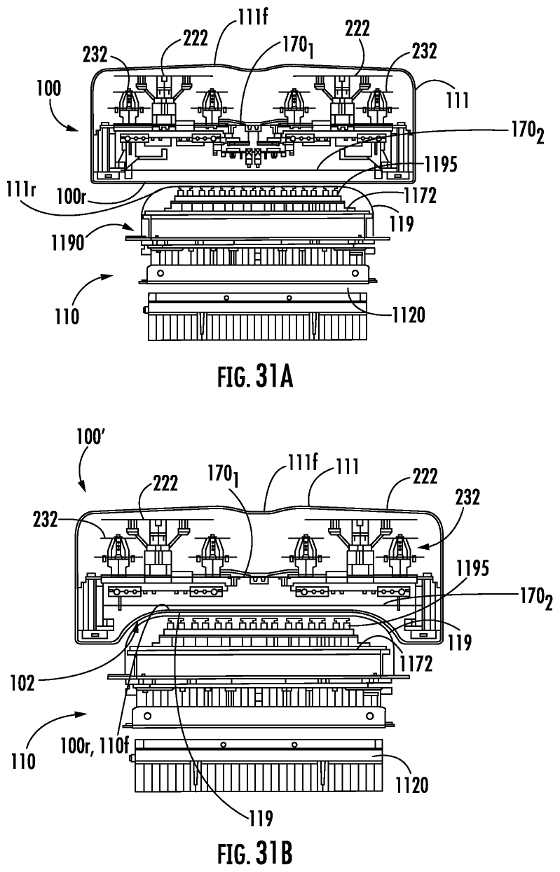

The base station antenna 100 can couple to or include at least one active antenna module 110. The term “active antenna module” is used interchangeably with “active antenna unit” and “AAU” and “active antenna” and refers to a cellular communications unit comprising radio circuitry and associated radiating elements. The radio circuitry is capable of electronically adjusting the amplitude and/or phase of the subcomponents of an RF signal that are output to different radiating elements of an array or groups thereof. The active antenna module 110 comprises the radio circuitry and the radiating elements (e.g., a multi-input-multi-output (mMIMO) beamforming antenna array) and may include other components such as filters, a calibration network, an antenna interface signal group (AISG) controller and the like. The active antenna module 110 can be provided as a single integrated unit or provided as a plurality of stackable units, including, for example, first and second sub-units such as a radio sub-unit (box) with the radio circuitry and an antenna sub-unit (box) with a multi-column array of radiating elements and the first and second sub-units stackably attach together in a front to back direction of the base station antenna 100, with the radiating elements 1195 of an antenna assembly 1190 (FIGS. 31A, 31B) closer to the front radome 111f of the housing 100h/radome 111 of the base station antenna 100 than the radio circuitry unit 1120. In some embodiments, the radiating elements 1195 may comprise a separate sub-unit from the radio circuitry and the radiating element sub-unit may be mounted within the base station antenna 100 instead of being external to the base station antenna 100.

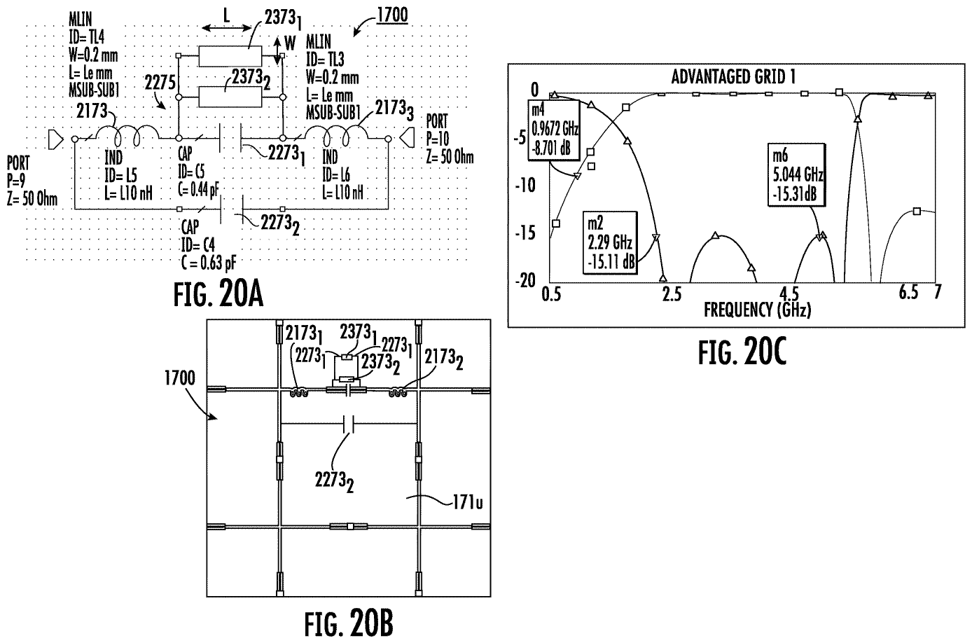

As will be discussed further below, the base station antenna 100 includes an antenna assembly 190, which can be referred to as a “passive antenna assembly”. The term “passive antenna assembly” refers to an antenna assembly having arrays of radiating elements that are coupled to radios that are external to the antenna, typically remote radio heads that are mounted in close proximity to the base station antenna 100. The arrays of radiating elements included in the passive antenna assembly 190 (FIG. 20A) are configured to form static antenna beams (e.g., antenna beams that are each configured to cover a sector of a base station). The passive antenna assembly 190 can comprise a reflector 170, 214 with radiating elements projecting in front of the reflector and the radiating elements can include one or more linear arrays of low band radiating elements that operate in all or part of the 617-960 MHz frequency band and/or one or more linear arrays of mid-band radiating elements that operate in all or part of the 1427-2690 MHz frequency band. The passive antenna assembly 190 is mounted in the housing 100h of base station antenna 100 and one or more active antenna modules 110 can releasably (detachably) couple (e.g., directly or indirectly attach) to base station antenna 100.

The base station antenna 100 has a housing 100h. The housing 100h may be substantially rectangular with a flat rectangular cross-section. The housing 100h may be provided to define at least part of a radome 111 with at least the front side 111f configured as a dielectric cover that allows RF energy to pass through in certain frequency bands. The housing 100h may also be configured to that the rear 100r defines a rear side 111r radome opposite the front side radome 111f. Optionally, the housing 100h and/or the radome 111 can also comprise two (narrow) sidewalls 100s, 111s facing each other and extending rearwardly between the front side 111f and the rear side 111r. Typically, the top side 100t of the housing 100h may be sealed in a waterproof manner and may comprise an end cap 120 and the bottom 100b of the housing 100h may be sealed with a separate end cap 130. The front side 111f, the sidewalls 111s and typically at least part of the rear side 111r of the radome 111 are substantially transparent to radio frequency (RF) energy within the operating frequency bands of the base station antenna 100 and active antenna module 110. The radome 111 may be formed of, for example, fiberglass or plastic.

Still referring to FIG. 2A, in some embodiments, an active antenna module 110 can reside behind, and may optionally attach to, the base station antenna 100. The base station antenna 100 can comprise a frame 112 and accessory mounting brackets 113, 114. The rear 111r of the housing 100h may be a flat surface extending along a common plane over an entire longitudinal extent thereof or along at least a portion of the longitudinal extent thereof.

FIG. 2B illustrates that the rear surface 100r can comprise a recessed and/or stepped segment 102 facing the active antenna module 110. The stepped segment 102 resides closer to a front 100f of the housing than the back wall that is defined by a primary segment of the rear 100r of the housing 100h. The stepped segment 102 can have a lateral and longitudinal extent that is the same or greater than a lateral and longitudinal extent of the active antenna module 110. The rear surface 100r can also comprise a pair of spaced apart longitudinally extending rails 118 that engage an adapter mounting bracket 1118 on the active antenna module 110 to attach the active antenna module 110 to the base station antenna housing 100h. However, other mounting configurations may be used.

Referring again to FIG. 2A, in another embodiment, the rear surface 100r can comprise a plurality of longitudinally spaced apart mounting structure brackets, shown as upper, medial, and lower brackets, 115, 116, 117, respectively, that extend rearwardly from the housing 100h. In some embodiments, the mounting structure brackets 115, 116, 117 may be configured to couple to one or more mounting structures such as, for example, a tower, pole or building (not shown). At least two of the mounting structure brackets 115, 116 can also be configured to attach to the frame 112 of the base station antenna arrangement, where used. The frame 112 may extend over a sub-length of a longitudinal extent L of base station antenna 100, where the sub-length is shown in FIG. 2A as being at least a major portion thereof (at least 50% of a length thereof). The frame 112 can comprise a top 112t, a bottom 112b and two opposing long sides 112s that extend between the top 112t and the bottom 112b. The frame 112 can have an open center space 112c extending laterally between the sides 112s and longitudinally between the top 112t and bottom 112b.

The frame 112, where used, may be configured so that a variety of different active antenna modules 110 can be mounted to the frame 112 using appropriate accessory mounting brackets 113, 114. As such, a variety of active antenna modules 110 may be interchangeably attached to the same base station antenna 100. While the frame 112 is shown by way of example, other mounting systems may be used.

In some embodiments, a plurality of active antenna modules 110 may be concurrently attached to the same base station antenna 100 at different longitudinal locations using one or more frames 112. Such active antenna modules 110 may have different dimensions, for example, different lengths and/or different widths and/or different thicknesses.

Turning now to FIG. 3, an example primary reflector 214 for a base station antenna 100 is shown. As shown, the primary reflector 214 has a first section 214₁ that extends a first longitudinal distance and that merges into a second section 214₂ with spaced apart right and left side segments 214s having a lateral extent d2 that is less than a lateral extent dl of the first section 214₁. An open medial region 14 can extend longitudinally and laterally about the second section 214₂. The open medial region 14 can have a lateral extent d3 that is 60-95% of the lateral extent d1, in some embodiments. The first section 214₁ can have a longitudinal extent that is greater than the second section 214₂, typically at least 20% greater, such as 30%-80% greater, in some embodiments.

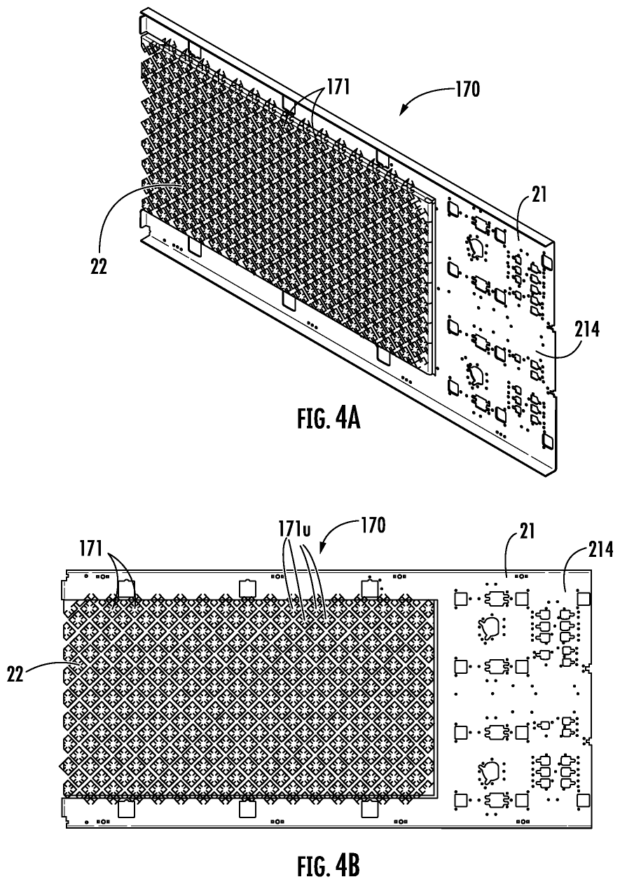

FIGS. 4A and 4B illustrate an example grid reflector 170 for base station antennas 100. The grid reflector 170 comprises a frequency selective surface and may interchangeably be referred to as a “frequency selective reflector” or “frequency selective surface layer”. The grid reflector 170 can extend part of or a full lateral extent of the base station antenna 100 and at least a part of a length of the base station antenna 100.

In some embodiments, the grid reflector 170 can be electrically and/or mechanically coupled to the primary reflector 214. In some embodiments, the grid reflector 170 can be positioned to reside between the right and left sides 214s of the primary reflector in the open medial region 14 (FIG. 3).

The grid reflector 170 can be provided as a non-metallic substrate(s) with metal patches arranged to define an array of unit cells 171 (also interchangeably referred to as “pattern units”) or can be a metal grid and comprises an array of unit cells 171.

The non-metallic substrate can be provided as a multiple-layer printed circuit board (PCB) which can be rigid, semi-rigid or provided as a flex circuit. The non-metallic substrate can be a plastic, polymer, co-polymer with a metallized surface(s) providing conductive patches.

The grid reflector 170 can be provided as a thin (e.g., 5 mil) PCB attached to a dielectric such as a polycarbonate matching layer or other suitable substrate. The grid reflector 170 can be defined by a thicker PCB, such as a 15 mil or 30 mil PCB.

The grid reflector 170 can be provided as a sheet of metal, such as aluminum, with the grid shaped to form the pattern units/unit cells 171u, e.g., the array of unit cells 171 can be etched, punched or laser formed through the sheet metal or otherwise formed.

The grid reflector 170 provides a frequency selective surface and/or substrate that is configured to allow RF energy (electromagnetic waves) to pass through at one or more first defined frequency range and that is configured to reflect RF energy at a different second frequency band. The frequency selective surface and/or substrate may be interchangeably referred to as a “FSS” herein. The grid reflector 170 of the base station antenna 100, can reside behind at least some antenna elements (see radiating elements 222, FIGS. 31A, 31B) and can selectively reject some frequency bands and permit other frequency bands to pass therethrough by including the frequency selective surface and/or substrate to operate as a type of “spatial filter”. See, e.g., Ben A. Munk, Frequency Selective Surfaces: Theory and Design, ISBN: 978-0-471-37047-5; DOI: 10.1002/0471723770; April 2000, Copyright @ 2000 John Wiley & Sons, Inc. the contents of which are hereby incorporated by reference as if recited in full herein.

The frequency selective surface and/or substrate material of the grid reflector 170 can comprise one or more of a metamaterial, a suitable RF material or even air (although air may require a more complex assembly). The term “metamaterial” refers to composite electromagnetic (EM) materials. Metamaterials may comprise sub-wavelength periodic microstructures.

The FSS 170 can be provided as one or more cooperating layers. The FSS 170 can include a substrate that has a dielectric constant in a range of about 2-4, such as about 3.7 and a thickness of about 5 mil and metal patterns formed on the dielectric substrate. The thickness can vary but thinner materials can provide lower loss.

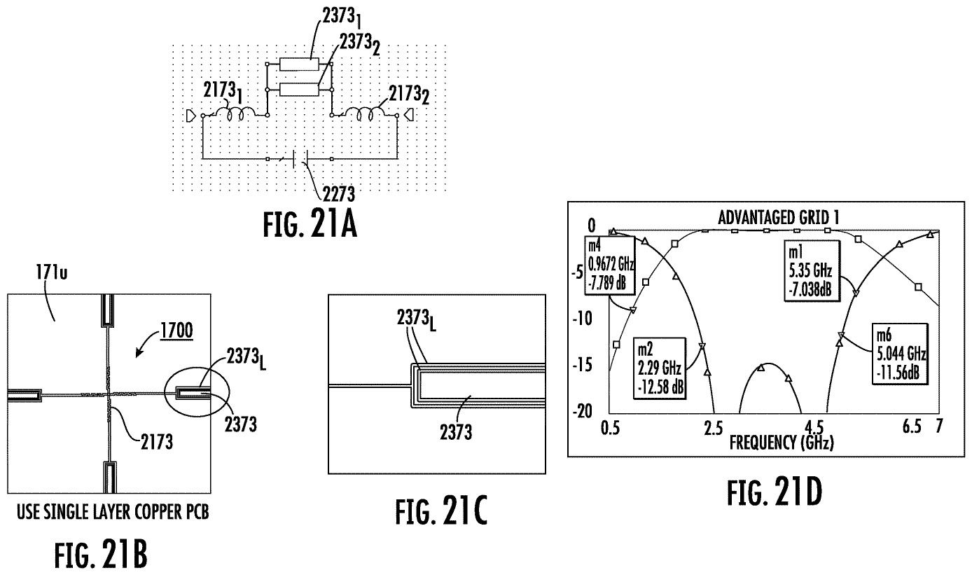

In some embodiments, the frequency selective substrate/surface 170 can be configured to act like a High Pass Filter essentially allowing low band energy to completely reflect (the FSS can act like a sheet of metal) while allowing higher band energy, for example, about 3.5 GHz or greater, to completely pass through. Thus, the frequency selective substrate/surface is transparent or invisible to the higher band energy and a suitable out of band rejection response from the FSS can be achieved. The FSS material may allow a reduction in filters or even eliminate filter requirements for looking back into the radio 1120 (FIGS. 21A, 21B).

In some embodiments, the FSS 170, for example, may be implemented using two or more closely spaced apart grids or FSS layers 170₁, 170₂ stacked in a Z direction, either one or both of which can be provided as a multi-layer printed circuit board, with the different layers providing a respective frequency selective surface configured such that electromagnetic waves within a predetermined frequency range cannot propagate through the FSS layers 170₁, 170₂, and one or more other predetermined frequency range is allowed to pass therethrough. Thus, the stacked FSS layers 170₁, 170₂ can be spaced apart in the Z direction and can cooperate to provide at least one rejection band and a (wider) pass band.

Referring to FIGS. 4A and 4B, a grid (frequency selective) reflector 170 according to embodiments of the present disclosure is shown. The grid reflector 170 can be used in the base station antenna 10 shown in FIGS. 2A, 2B, for example. The grid reflector 170 may include a main body 21 and a frequency selective section 22 provided in the main body 21. At least the main body 21 and/or the primary reflector 214 may be metallic (e.g., formed of aluminum). The frequency selective section 22 may be provided at a position of the grid reflector 170 corresponding to the installation position of the active antenna module 110 of the base station antenna 100 and may be configured to allow electromagnetic waves within a predetermined frequency range (for example, high-frequency electromagnetic waves within the range of 2300 to 5000 MHz or a portion thereof, e.g., electromagnetic wave in a 2900-4000 MHz range or 3400-5000 MHz range) to pass. In this way, when the base station antenna 100 is assembled, the high-frequency electromagnetic waves emitted by the active antenna module 110 can pass through the frequency selective reflector 20 via the frequency selective section 22.

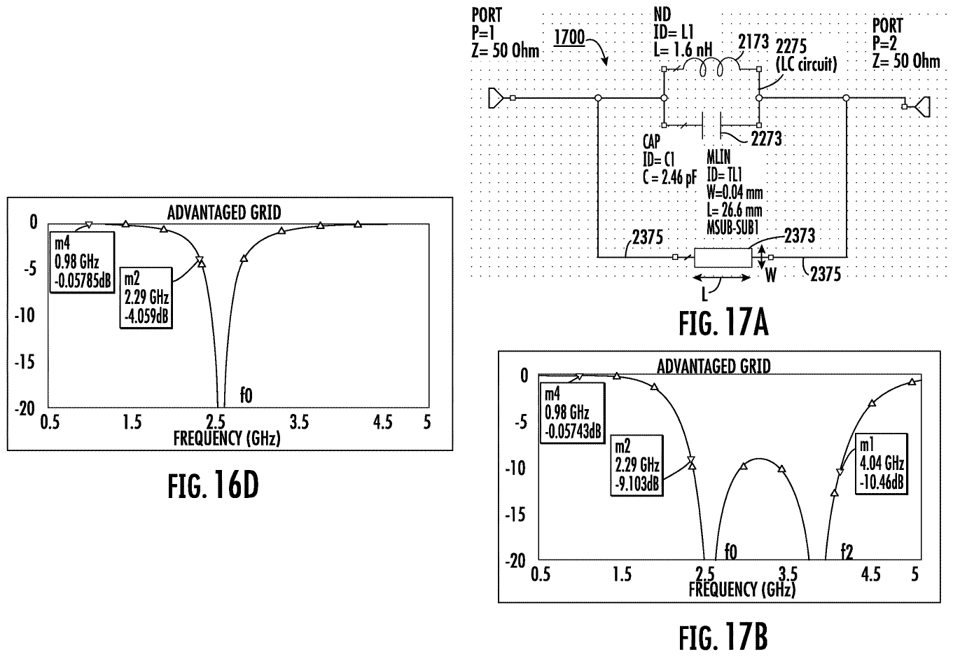

The frequency selective section 22 may be composed of an array 171 of a plurality of pattern units or unit cells 171u that are periodically arranged in the transverse and longitudinal directions of the base station antenna. Each of the pattern units/unit cells 171u may have a predetermined pattern and may include a capacitor structure and an inductor structure connected in series (FIG. 16A) or in parallel (FIG. 16B) with a capacitor structure.

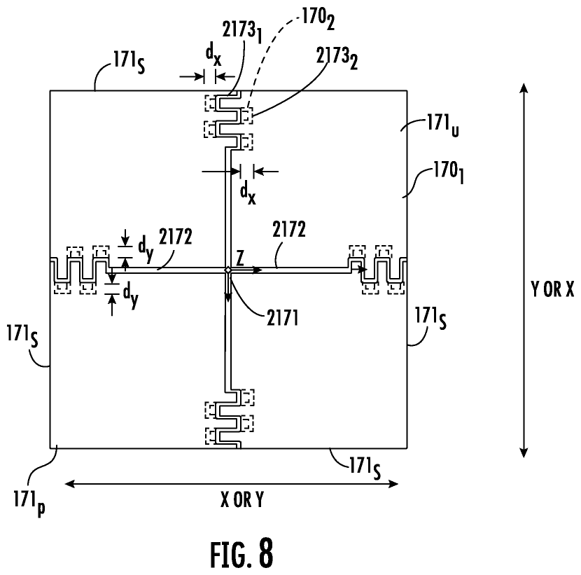

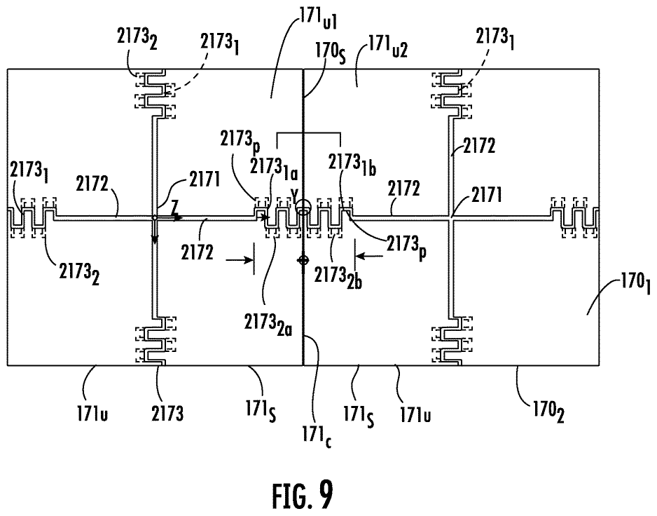

In addition, each of the pattern units 171u of the array 171 may be electrically connected to each other through the inductor structure. For example, an inductor structure 2173 in each pattern unit/unit cell 171u may be electrically connected to the inductor structure 2173 of a neighboring, adjacent pattern unit (FIGS. 9, 13).

The resonance frequency of the frequency selective section 22 may be configured by selecting or designing the pattern and size of the capacitor structure and the inductor structure of each pattern unit/unit cell 171, as well as the spacing and arrangement of a plurality of pattern units 171 such that the electromagnetic waves within a predetermined frequency range can pass through the frequency selective section 22.

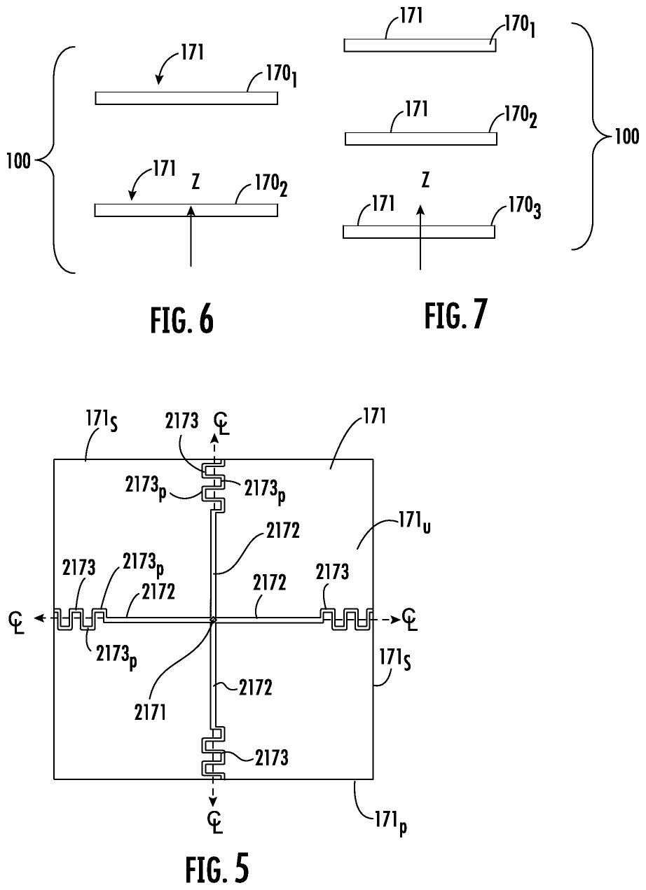

Referring to FIG. 5, an example unit cell (or “pattern unit”) 171u of an array or pattern of unit cells 171 for an FSS 170 according to embodiments of the present disclosure are shown. The unit cell 171u has a center 2171 with four linear segments 2172 extending orthogonal from each other, defining a “cross” pattern. The four linear segments 2172 project outward from the center 2171 and each of the four linear segments 2172 merge into respective inductor features 2173 that extend either laterally or longitudinally from respective sides 171s of a perimeter 171p of a respective unit cell 171u.

Each unit cell 171u can have a simple shape so as to have less effect on both small incident angles and large incident angles. Positioning the inductor features 2173 to extend adjacent to each of the four outer perimeter sides 170s can provide an improved performance at a working band which can allow easy adjustability of the inductance for the s-parameter of the working band for different base station antennas 100. This inductor feature structure can also have broadband characteristics.

FIG. 6 illustrates that the base station antenna 100 can comprise at least first and second FSS layers 170₁, 170₂, stacked in a front to back (Z) direction, and each can comprise the array of unit cells 171.

Each FSS layer 170₁, 170₂ can be spaced apart from each other about 1/10-½ of an operating wavelength, such as about a ¼ of an operating wavelength of the high band radiating elements 1195 behind the second FSS 170₂ or the low band radiating elements 222 in front of the first FSS layer 170₁. The term “operating wavelength” refers to the wavelength corresponding to the center frequency of the operating frequency band of a radiating element, e.g., a low band radiating element 222 or a high band radiating element 1195. The spacing between the FSS layers, e.g., 170₁ and 170₂, can be about 1/10-½ (typical ¼) of the operating wavelength and is related to the electrical length. For example, placing a higher dielectric constant (DK) material in between can allow a smaller spacing.

The first FSS 170₁ and the second FSS 170₂ can reside a distance in a range of 1/10 wavelength to ½ wavelength of an operating wavelength in front of the high band radiating elements 1195, in some embodiments.

Referring to FIG. 7, the base station antenna 100 can comprise at least first, second and third FSS layers 170₁, 170₂, 170₃, stacked closely spaced apart, in a front to back (Z) direction, and each can comprise the array of unit cells 171. Each FSS layer 170₁, 170₂, 170₃ can be spaced apart from each other about a 1/10-½ of an operating wavelength, such as about ¼ wavelength of an operating wavelength of the high band radiating elements 1195 behind the third FSS 1703 and/or the low band radiating elements 222 in front of the first FSS layer 170₁. Using three or more FSS layers 170₁, 170₂, 170₃ can facilitate a wider bandwidth and/or a higher reflection at low band. Using three or more stacked FSS layers can provide a greater/higher reflection at low band.

The two or three FSS structures of FIGS. 6 and 7 can be configured to have a pass band for mMIMO radiating elements 1195 (FIGS. 21A, 21B) comprising at least some frequencies in a range of, for example: 3150-5000 MHz and 2200-4200 MHz and all the sub-band in between, such as 2490-2690 MHz, 3400-3980 MHz, and 2900-4000 MHz.

FIG. 8 shows a unit cell 171u of each of the first and second FSS layers 170₁, 170₂, aligned in X and Y directions, with the second FSS layer 1702 behind (in the Z direction), the first FSS layer 170₁ and with the center 2171 of the front/first FSS layer 1701 at substantially the same location as the center 2171 of the back/second FSS layer 1702 and with the linear segments 2172 of each FSS layer 170₁, 170₂, also aligned so that the linear segments 2172 of the front FSS 170₁ are at substantially the same X-Y location as the linear segments 2172 of the back FSS 170₂. Here, the term “substantially” means within +/−10% of each other in X and/or Y directions.

The inductor features 2173₂ of the second FSS layer 1702 can be configured to have a different inductance value(s) than the inductor features 21731 of the first FSS layer 1701. The inductor features 21732 of the second FSS layer 1702 can have a different size and/or different shaped inductor features, shown as having projections 2173p that project laterally a distance dx or longitudinally a distance dy further than corresponding inductor features 2173₁ of the first FSS layer 170₁.

The inductor features 2173 can be configured to have different inductance values which can depend on a distance of the respective FSS layer 170₁, 170₂ from the front 100f and/or rear radome 100r (FIG. 2B) or radome 119 of the AAU 110 (FIGS. 21A, 21B). The inductance values may also vary based on wide band operation when used for 5G operation, for example, or whether positioned behind low band or mid-band radiating elements 222, 232, respectively (FIGS. 21A, 21B). The thickness and DK of the radome(s) 111f and/or 119 can be a key factor for selecting the appropriate inductance values.

The inductor features 2173 can be formed with symmetric laterally extending projections 2173p on two sides 171s of the respective unit cell 171u and symmetric longitudinally extending projections 2173p on the other two sides 171s of the respective unit cell 171u, with the projections 2173p extending about and opposite to a virtual center line C/L that extends from and is aligned with the corresponding linear segment 2172. The inductor features 2173 of each of the first and second FSS layers 170₁, 170₂ can extend a common distance, starting spaced apart a distance from the center 2171, to the perimeter 171p of a respective unit cell 171u.

FIG. 9 illustrates two neighboring unit cells 171u1, 171u2 for each stacked first and second FSS layers 170₁, 170₂. As shown, a first inductor structure 2173₁a on the first FSS layer 170₁ merges into a second inductor structure 2173₁b at a common 171c, shared perimeter side 171s. The second FSS layer 1702 also provides the neighboring unit cells 171u1, 171u 2 with respective first and second inductor structures 2173₂a, 2173₂b connected at the common 171c shared perimeter side 171s. The first and second inductor structures 2173₂a, 2173₂b of the second FSS layer 170₂ have projections 2173p that are behind and aligned in the X, Y direction with the first and second inductor structures 2173₁a, 2173₁b of the first FSS layer 170₁ but which extend longitudinally outside a boundary of corresponding projections 2173p on the first FSS layer 170₁. The other three sides 171s of a respective unit cell 171u1 and 171u2 can have similar connected inductor structures 2173.

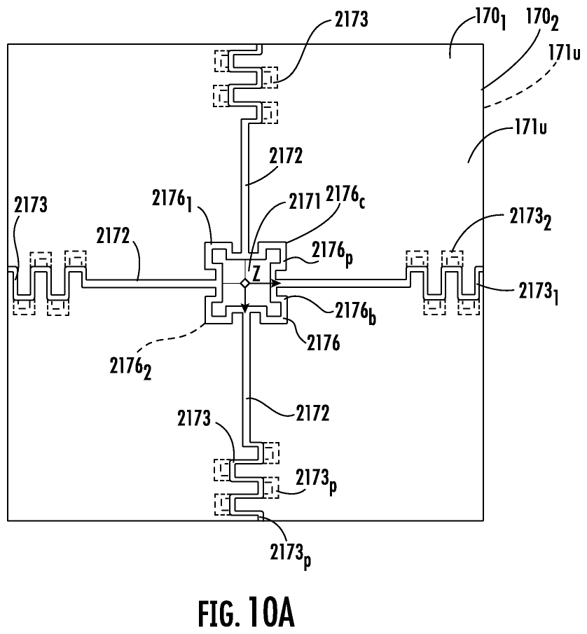

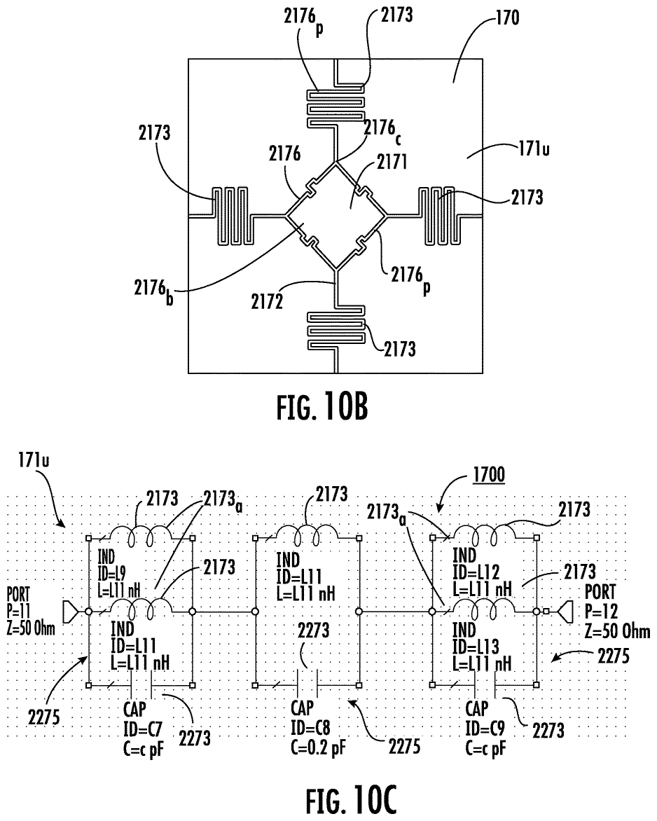

FIG. 10A illustrates another embodiment of an example unit cell 171u. In this embodiment, the center 2171 is surrounded by a shaped pattern 2176 that is symmetric on four sides with a curvilinear perimeter 2176p that merges into the four linear segments 2172 that are orthogonal to each other and that then merge into the inductor structures 2173. The shaped pattern 2176 can be a box pattern 2176b with four corners 2176c.

FIG. 10A also shows the first FSS layer 170₁ in front of and over the second FSS layer 170₂ with the respective aligned unit cells 171u. The shaped pattern 2176₂ surrounding the center 2171 on the second FSS layer 170₂ is aligned in the X-Y direction with the shaped pattern 2176₁ on the first FSS layer 170₁ so that it is “hidden” in the illustrated view by the shaped pattern 2176 on the first FSS layer 170₁.

FIG. 10B shows an alternate configuration of at least one of FSS layer 170 with the unit cells 171u having the inductor structures 2173 and a shaped (metal) pattern 2176p surrounding the center 2171. In this embodiment, the shaped pattern 2176p is configured so that the box pattern 2176b is turned 90 degrees from the orientation in FIG. 10A and with the inductor structures connecting at respective corners, with each of the four inductor structures 2173 merging into a different one of the four corners 2176c of the box pattern 2176b.

Referring to FIG. 10C, the unit cells 171u can be arranged to provide a wideband FSS with equivalent circuits 1700 comprising a respective capacitor 2273 in parallel to a respective inductor 2173 forming three LC circuits 2275, two of which have a pair of inductors in parallel with each other and the capacitor 2273 and a center one having a single LC circuit 2275 without the parallel inductors 2173a.

The circuit 1700 can provide a high pass filter and the inductance/inductor can be very small. Alternatively, the circuit 1700 can provide a low pass filter and the capacitor/capacitance can be very small. The inductance L and the capacitance C can be calculated by SRF=½π√LC. As is known by those of skill in the art, “SRF” means “self-resonant frequency”. In the antenna or circuit design, this frequency can correlate to a middle/center frequency of the working band.

FIG. 11 illustrates yet another embodiment of an example unit cell 171u. In this embodiment, four linear segments 2172 extend form the center 2171, orthogonal to each other, and again merge into inductor structures 2173 with projections 2173p as discussed above with respect to other embodiments. In this embodiment, the inductor structures 2173 reside a closer distance to the center 2171 and terminate before the outer perimeter sides 171s so that there are outer linear segments 2178 that extend from the inductor structures 2173 to the outer perimeter sides 170s. In this embodiment, inductor structures 2173 of neighboring unit cells 171u will be connected via the outer linear segments 2178. Thus, in this embodiment, the four linear segments 2172 are inner linear segments and one inductor structure 2173 can reside between each pair of outer and inner linear segments 2178, 2172, respectively.

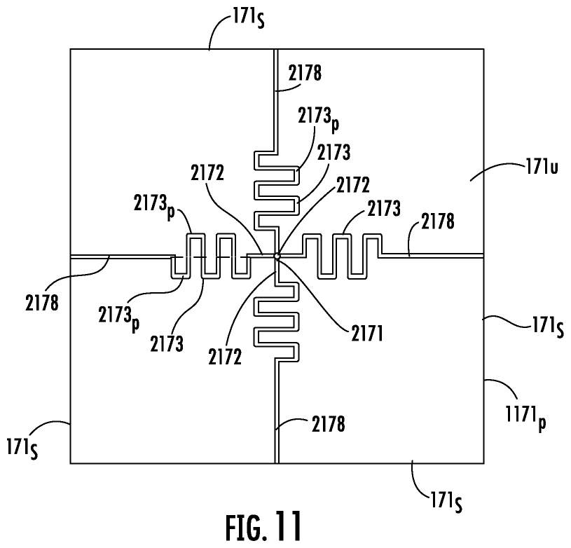

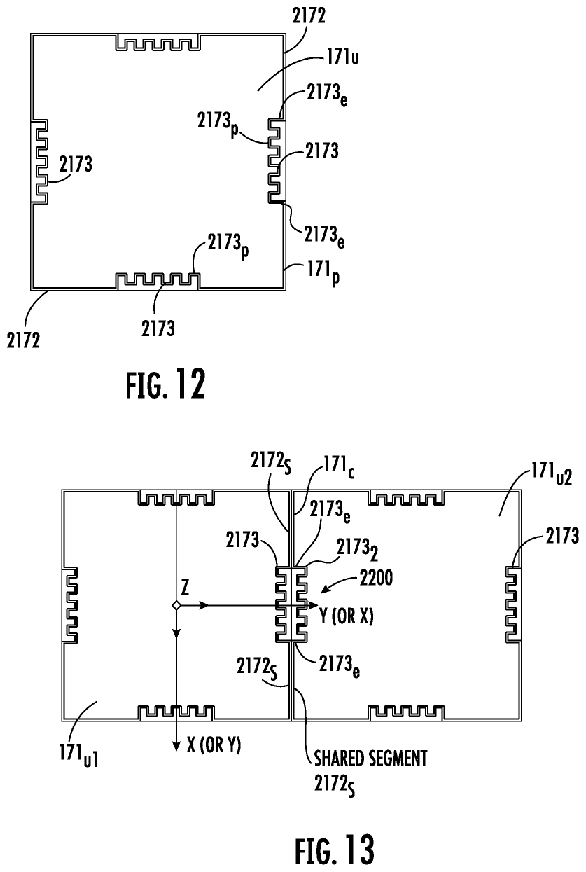

FIG. 12 illustrates another embodiment of an example unit cell 171u. In this embodiment, the inductor structures 2173 reside spaced apart about the perimeter of the unit cell 171u. The perimeter 171p has linear segments 2172 that connect the spaced apart inductor structures 2173. A major portion, such as 60-95 percent, of a surface area of the unit cell 171 in the X-Y directions, including the center 2171, can be open and/or devoid of any metal or metal trace(s). The inductor structures 2173 have projections 2173p that extend inwardly from the perimeter 171p. As shown, the linear segments 2172 stop at or merge into each end 2173e of the inductor structures 2173 so that they do not extend longitudinally or laterally at a position of the inductor structures 2173.

Referring to FIG. 13, for neighboring unit cells 171u1, 171u2, the linear segments 2172 can be provided as shared linear segments 2172s at a common 171c outer perimeter side 170s and the corresponding inductor structures 2173₁, 2173₂ can project inwardly from the shared linear segments 2172s. The shared, common side 170c is configured with two inductor structures 2173₁, 2173₂ defining a parallel inductor circuit 2200 thereat.

Adjusting the inductance provided by the inductor structures 2173 can provide a good s-parameter for a working band for various implementations of base station antennas 100.

The parallel inductor circuit 2200 can be configured to provide the same inductance as a single inductor 2173 for a unit cell 171u. For unit cells 171u provided in a metal substrate or by larger metal patterns, the reflection of low band can be greater/higher, but the passband s-parameter may be degraded a little relative to narrow metal traces on a dielectric layer.

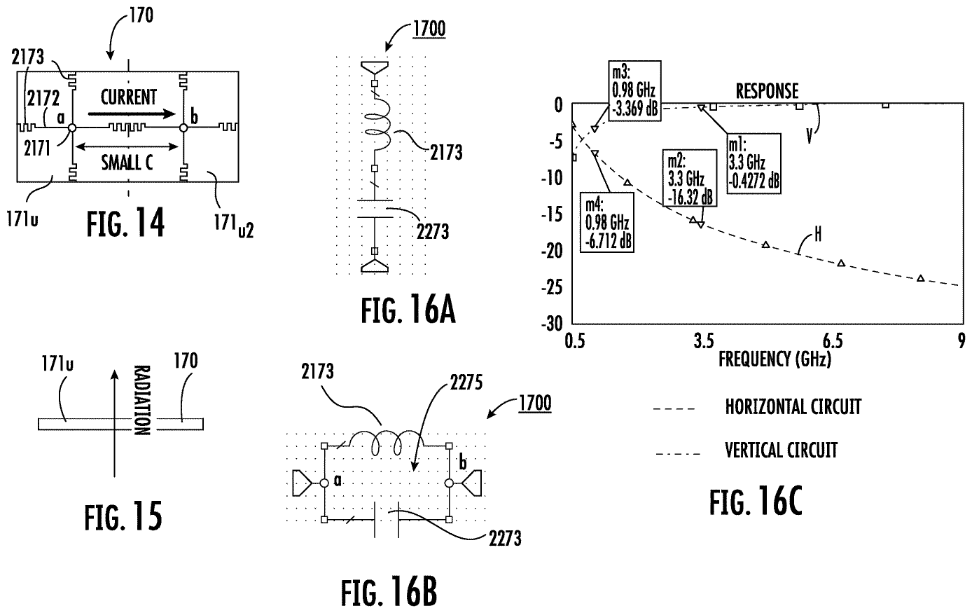

FIG. 14 illustrates a circuit schematic of an example current flow direction based on radiation projecting in the Z direction (FIG. 15) through an FSS layer 170 with the unit cells 171u. The capacitance is very small.

The unit cells 171u can be arranged to provide equivalent circuits 1700 as shown in FIG. 16A (vertical equivalent circuit with a capacitor 2273 in series with the inductor 2173) and FIG. 16B (horizontal equivalent circuit between nodes a, b shown in FIG. 14, with the capacitor 2273 in parallel to the inductor 2173 forming an LC circuit). In FIG. 16A, the circuit 1700 can provide a high pass filter and the inductance/inductor is very small. In FIG. 16B, the circuit 1700 can provide a low pass filter and the capacitor/capacitance is very small. The inductance L and the capacitance C can be calculated by SRF= 1/27π√LC. As is known by those of skill in the art, “SRF” means “self-resonant frequency”. In the antenna or circuit design, this frequency can correlate to a middle/center frequency of the working band.

The In some embodiments, the unit cells 171 of one or more of the FSS layers 170₁, 170₂, 170₃ can be configured as equivalent circuits that provide a high pass filter on a vertical and horizontal directions and the inductor structures 2173 can provide a broken high band current space. High band current can go across the inductor while low band can be rejected.

FIG. 16C illustrates a simulated wideband FSS response (db) versus frequency (GHz) for example m1-m4 parameters for the circuits 1700, the horizontal equivalent circuit H (FIG. 16B) and the vertical equivalent circuit V (FIG. 16A).

FIG. 16D shows a simulated response of a base sample LC circuit that acts as a baseline. The response frequency is f0 (about 2.5 GHz) m2 is a start point of the bandpass and m4 is the end point of the bandstop.

Turning now to FIG. 17A, the (equivalent unit cell) circuit 1700 of the FSS 170 can comprise a transmission (“TX”) line segment 2373 that can be electrically coupled to an inductor 2173. As shown, the inductor 2173 forms an LC circuit with a capacitor 2273. The transmission line segment 2373 is parallel to the LC circuit 2275. The dimensions of the TX line segment 2373 can have a width dimension W that can optionally be less than a length dimension L. The TX line segments 2373 can be wider than microstrip trace segments 2375 on opposing ends thereof. The length L can be about half wavelength of the second response point f2 and the width W can be any value because that is equivalent to the L and C value. The width W can be configured (equal to adjust L/C) to achieve a high Q value and/or a low Q value, depending on the target design.

In some particular, embodiments, the TX line segment 2373 can have a width dimension W that is in a range of 0.02 mm to 0.2 mm. In some particular embodiments, the length dimension L can be in a range of 10-30 mm, such as about 22.6 mm, in some embodiments.

In some embodiments, the length dimension L of the TX line segment 2373 can be configured so that signals traversing the TX line segment undergo a 180-degree phase shift at a defined frequency f2. The defined frequency f2 can be in a high band range such as in a range between 3.5 and 6.5 GHz in some embodiments.

FIG. 17B shows a simulated response graph of the wideband FSS grid, frequency (GHz) versus decibel, with f0 and f2 as well as example m1, m2 and m4 parameters for the equivalent circuit 1700 shown in FIG. 17A. By adding the additional TX line segment 2373 in the circuit 1700, the second response frequency point occurs, and the total bandwidth can be extended. The f2 is the second response frequency point.

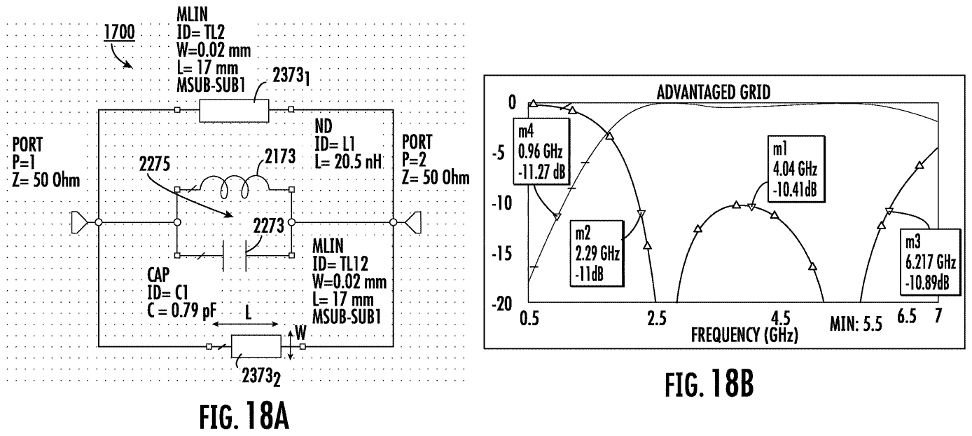

FIG. 18A shows another example equivalent circuit 1700 with first and second transmission line segments 2373₁, 2373₂, coupled to the LC circuit 2275, one above and in parallel to the LC circuit 2375 and one below and in parallel to the LC circuit 2275. The two transmission line segments 2373₁, 2373₂ can have a length dimension L that can be shorter than that shown in FIG. 17A, such as about 17 mm, in some embodiments. The super wide band FSS equivalent circuit 1700 can be configured so that phase increases: PH2-arc tan (X/R) where X is fixed and imaginary and R is real series circuit. Adding a second TX line segment 2373, the Q value of the circuit 1700 can get lower and extend the bandwidth of the bandpass.

FIG. 18B shows a simulated response graph of the wideband FSS grid, frequency (GHz) versus decibel, with f0 and f2 as well as example m1, m2, m3 and m4 parameters for the equivalent circuit 1700 shown in FIG. 18A. As shown, f0 can be in a range of 2-3 GHz, such as about 2.5 GHz while f2 can be in a range of 4.5-6.5 GHz, such as about 5.5 GHz minimum.

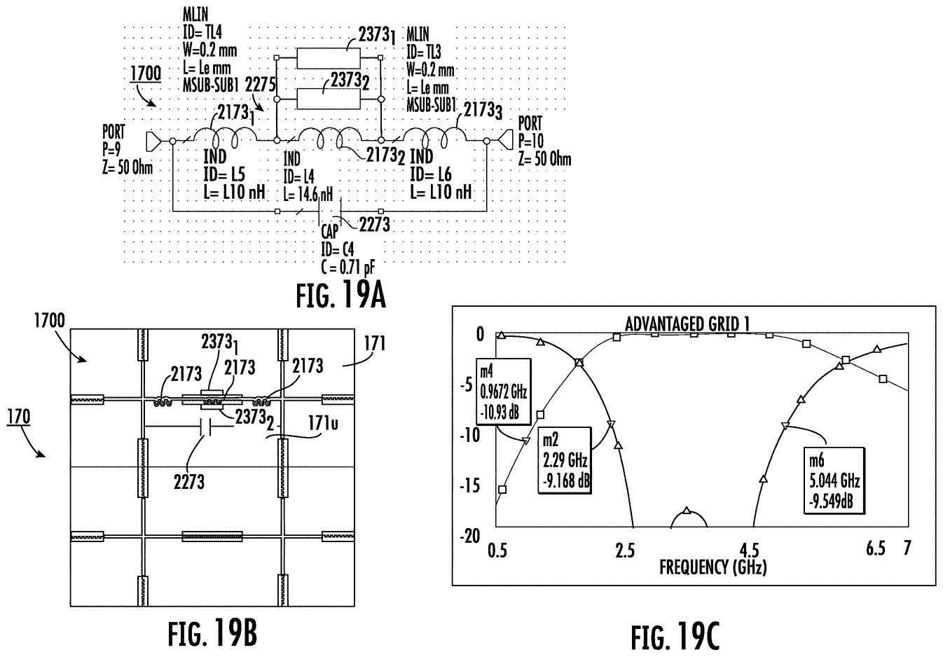

FIG. 19A shows another example equivalent circuit 1700 with first and second transmission line segments 2373₁, 2373₂, coupled to a plurality of the inductors 2173 in series, shown as first, second and third inductors 2173₁, 2173₂, 2173₃. The second (middle) inductor 21732 can have a greater inductance than the end inductors 2173₁, 2173₃. The unit cell (equivalent) circuit 1700 can include a capacitor 2273. The circuit 1700 can comprise a second capacitor 2273₂ in parallel to the first capacitor 2273₁. The first and second transmission line segments 2373₁, 2373₂ can both be on a common side (shown both above) and in parallel to the second capacitor 2273₂.

FIG. 19C shows a simulated response baseline response, frequency (GHz) versus decibel, with f0 and f2 as well as example m2, m4 and m6 parameters for the equivalent circuit 1700 shown in FIG. 19A. As shown, f0 can be in a range of 2-3 GHz, such as about 2.5 GHz while f2 can be in a range of 3.5-5 GHz, shown as about 4.5 GHz.

FIG. 19B is a schematic illustration of a plurality of unit cells 171u of a grid reflector 170 whereby at least some of the unit cells 171u can be configured to have the equivalent circuit 1700 shown in FIG. 19A.

FIG. 20A shows another example equivalent circuit 1700 with first and second transmission line segments 2373₁, 2373₂, coupled to a plurality of the inductors 2173. The inductors 2173 can be in series with a first capacitor 2273₁ therebetween. The circuit 1700 can comprise a second capacitor 2273₂ in parallel to the first capacitor 2273₁. The second capacitor 22732 can have a greater capacitance than the first capacitor 2273₁. The first and second transmission line segments 2373₁, 2373₂ can both be on a common side (shown both above) and in parallel to the capacitor 2273.

FIG. 20C shows a simulated response, frequency (GHz) versus decibel, with f0 and f2 as well as example m2, m4 and m6 parameters for the equivalent circuit 1700 shown in FIG. 20A. As shown, f0 can be in a range of 2-3 GHz, such as about 2.5 GHz while f2 can be in a range of 3.5-5 GHz, shown as about 4.5 GHz.

FIG. 20B is a schematic illustration of a plurality of unit cells 171u of a grid reflector 170 whereby at least some of the unit cells 171u can be configured to have the equivalent circuit 1700 shown in FIG. 20A.

FIG. 21A shows another example equivalent circuit 1700 with first and second transmission line segments 2373₁, 2373₂, coupled to a plurality of the inductors 2173. In this embodiment, the inductor of FIG. 19A and the capacitor of FIG. 20A are omitted from the circuit. Thus, a first inductor 2173₁ is attached to first ends of the TX line segments 2373₁, 2373₂, and a second inductor 2173₂ is attached to the opposing second ends of the TX line segments 2373₁, 2373₂. The circuit 1700 can comprise a capacitor 2273 coupled to the first and second inductors. The second capacitor 2273₂ can have a greater capacitance than the first capacitor 2273₁. The first and second transmission line segments 2373₁, 2373₂ can both be on a common side (shown both above) and in parallel to the capacitor 2273.

FIG. 21D shows a simulated response graph, frequency (GHz) versus decibel, with f0 and f2 as well as example m1, m2, m4 and m6 parameters for the equivalent circuit 1700 shown in FIG. 21A. As shown, f0 can be in a range of 2-3 GHz, such as about 2.5 GHz while f2 can be greater than f0 and in a range of 3.5-5 GHz, shown as about 4.5 GHz.

FIG. 21B is a schematic illustration of a plurality of unit cells 171u of a grid reflector 170 whereby at least some of the unit cells 171u can be configured to have the equivalent circuit 1700 shown in FIG. 21A. A single layer copper printed circuit board may provide the unit cells 171u. FIG. 21C is an enlarged portion of the unit cell shown in FIG. 21B showing parallel, adjacent trace lines 2373L forming part of the unit cell 171u. The parallel lines 2373L can be used for the TX line segment 2373 and can be configured so that one layer of copper or other conductive metal can be used for the unit cell 171u.

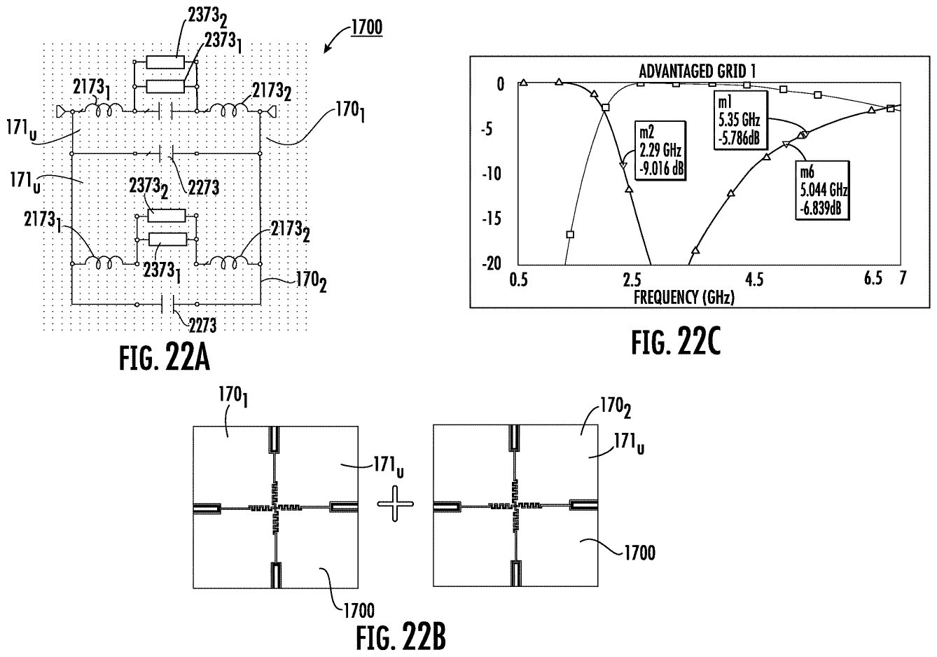

FIG. 22A shows another example of a wideband FSS using a double layer FSS configuration, each layer 1701, 1702 comprising cooperating components forming an equivalent circuit 1700 with components that can be electrically coupled and stacked in a front to back direction. Each layer 1701, 1702 comprises unit cells 171u with first and second transmission line segments 2373₁, 2373₂, coupled to a plurality of the inductors 2173. Each layer 1701, 1702 can comprise unit cells 171u with the same equivalent circuit 1700 configuration. In this embodiment, as discussed with respect to FIG. 21A, a first inductor 2173₁ is attached to first ends of the TX line segments 2373₁, 2373₂, and a second inductor 2173₂ is attached to the opposing second ends of the TX line segments 2373₁, 2373₂. The circuit 1700 can comprise a capacitor 2273 coupled to the first and second inductors. The second capacitor 2273₂ can have a greater capacitance than the first capacitor 22731. The first and second transmission line segments 2373₁, 2373₂ can both be on a common side (shown both above) and in parallel to the capacitor 2273.

FIG. 22C shows a simulated response graph, frequency (GHz) versus decibel, with f0 as well as example m1, m2 and m6 parameters for the equivalent circuit 1700 shown in FIG. 22A. As shown, f0 can be in a range of 2-3 GHz, such as about 2.5 GHz.

FIG. 22B is a schematic illustration of a plurality of unit cells 171u of first and second layers of grid reflectors 1701, 1702 whereby at least some of the unit cells 171u of each can be configured to have the equivalent circuit 1700 shown in FIG. 22A.

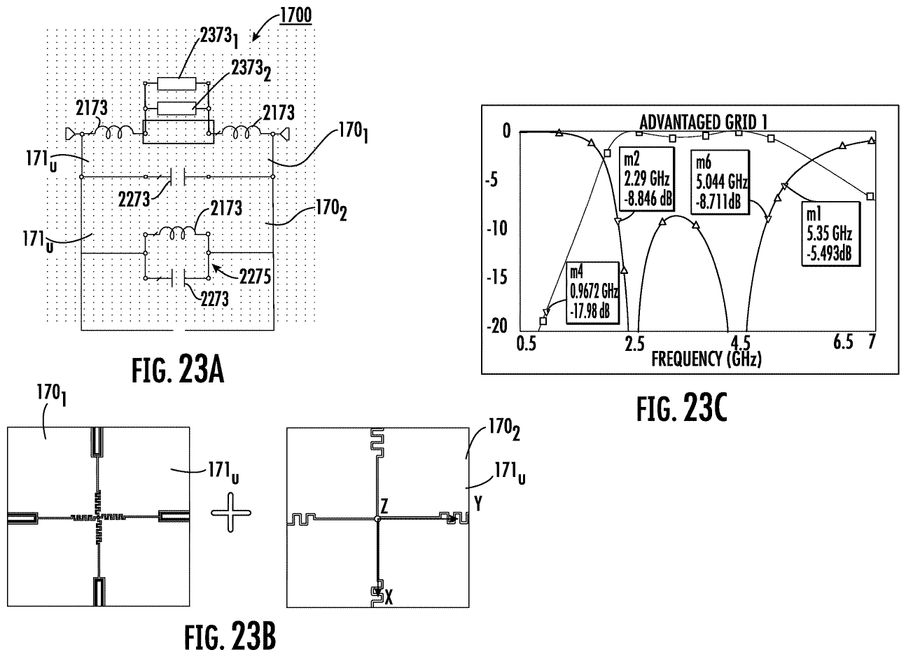

FIG. 23A shows another example of a wideband FSS using a double layer FSS configuration, each layer 1701, 1702 comprising components forming an equivalent circuit 1700 that can be electrically coupled and stacked in a front to back direction. Each layer 170₁, 170₂ comprises unit cells 171u with first and second transmission line segments 2373₁, 2373₂, coupled to a plurality of the inductors 2173. Each layer 1701, 1702 can comprise unit cells 171u with different equivalent circuit 1700 configurations. In this embodiment, the first layer 1701 comprises an equivalent circuit 1700 with a first inductor 2173₁ is attached to first ends of the TX line segments 2373₁, 2373₂, and a second inductor 2173₂ is attached to the opposing second ends of the TX line segments 2373₁, 2373₂. The circuit 1700 can comprise a capacitor 2273 coupled to the first and second inductors 2173₁, 2173₂. The second capacitor 2273₂ can have a greater capacitance than the first capacitor 2273₁. The first and second transmission line segments 2373₁, 2373₂ can both be on a common side (shown both above) and in parallel to the capacitor 2273. The second layer 1702 can have an equivalent circuit 1700 comprising an LC circuit 2275 coupled to the equivalent circuit provided by the first layer 1701.

FIG. 23C shows a simulated response graph, frequency (GHz) versus decibel, with f0 as well as example m1, m2 and m6 parameters for the equivalent circuit 1700 shown in FIG. 23A. As shown, f0 can be in a range of 2-3 GHz, such as about 2.5 GHz while f2 can be greater, such as in a range of about 3.5-5 GHz, shows as about 4.5 GHz.

FIG. 23B is a schematic illustration of unit cells 171u of first and second layers of grid reflectors 170₁, 170₂, closely stacked in a Z or front to back direction, whereby at least some of the unit cells 171u of each can cooperate to form the equivalent circuit 1700 shown in FIG. 23A.

FIG. 24A shows another example of a wideband FSS using a double layer FSS configuration, each grid FSS layer 170₁, 170₂ comprising unit cells 171u forming components of at least one equivalent circuit 1700 that can be electrically coupled and stacked in a front to back direction behind a front radome 111f of a base station antenna 100 (FIG. 2A).

FIG. 24B is a front view of the top layer 170₁ shown in FIG. 24A illustrating the grid layer 1701 can have cutout regions 1170 of material extending within and/or about respective unit cells 171u.

In some particular embodiments, one or both of the layers 1701, 1702 can optionally be formed of a low dielectric constant material, e.g., a DK in a range of 1-4, more typically 2-4.

The primary material of the substrate(s) providing the plurality of unit cells 171u may optionally comprise a low dielectric constant (DK) material. For changing the LC value in the equivalent circuit 1700 this can be carried out by changing the size of the metal and cutout area of the primary material and may comprise a high DK material characteristic.

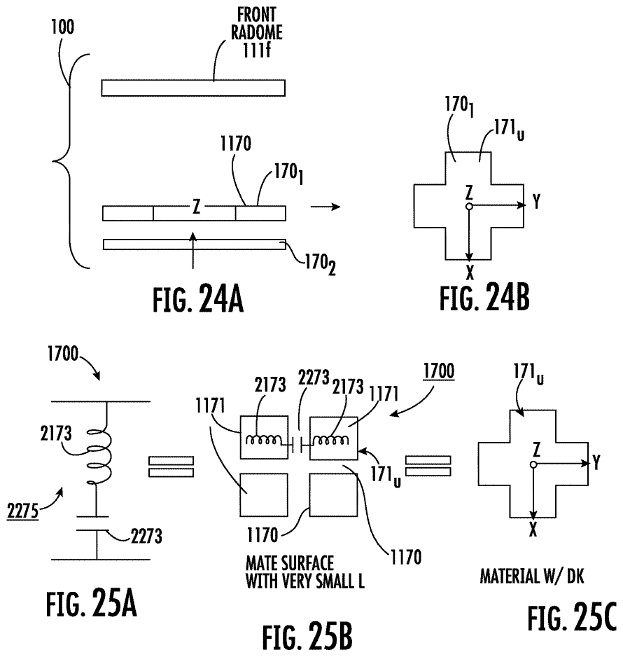

FIG. 25A shows the equivalent circuit 1700 with the inductor structure 2173 and capacitor 2273 forming an LC circuit 2275. FIG. 25B illustrates a meta material and/or surface 1171 can be configured to perform the circuit 1700 shown in FIG. 25A. FIG. 25C illustrates a dielectric material selected to perform at least part of the circuit 1700 shown in FIG. 25A. The L/C values of the inductor 2173 structure and capacitor 2273 of FIG. 25A can be selected based on the operational requirements and/or implementation such as the FSS layers 170₁, 170₂ shown in FIG. 24A.

The dielectric material is not required to be a low DK material. For example, if the configuration of the FSS layers 1701, 1702 shown in FIG. 24A, for example, need a different L/C, and this L/C can be provided by a high DK dielectric material, the high DK dielectric material can be used in the FSS layers shown in FIG. 24A.

It should be noted that if the DK is too high such that it is difficult to obtain or is expensive, a meta surface option can be used such as that shown in FIG. 25B. The meta material 1171 can comprise neighboring segments separated by cutout segments providing a very small capacitance 2273 and the meta material 1171 can provide the inductance.

It is noted that although the unit cells 171u are shown as having square perimeters in some of the drawings, other shapes can be used. The different “sides” can be provided based on the shape, e.g., a circular unit cell 171u can have circumferentially spaced apart inductor structures that extend about the perimeter of that extend radially from the center. The unit cells 171u may have various shapes, such as triangle, rectangle, rhombus, pentagon, hexagon, circle, oval, and the like and combinations of different shapes for different unit cells.

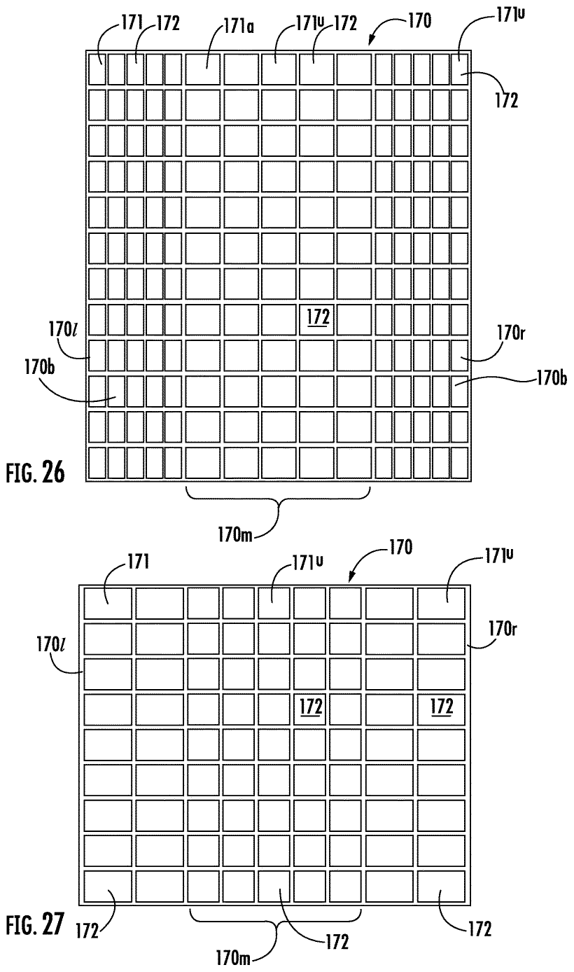

It is noted that the larger inductor or inductor with greater inductance may be provided on either the front or back FSS layer 170₁, 170₂, depending on the application/use. Also, the array of unit cells 171 can be provided with different shapes or density of unit cells 171u at different positions (see, FIGS. 26, 27, 28).

Referring to FIGS. 26, 27 and 28, the grid reflector 170 can be configured so that there are different densities of unit cells 171u at different locations. In some embodiments the grid reflector 170 can be configured so that unit cells 171u may be asymmetric about one or more axes to, for example, improve cross-polarization performance.

FIG. 26 illustrates the array 171 of unit cells 171u can be arranged with a greater density of unit cells 171u at left and right side portions, 170r, 170l relative to a medial portion 170m. FIG. 26 also illustrates that unit cells 171 located at a medial portion 170m of the grid reflector 170, can have a larger surface area, height and/or width, shown as a common height dimension and different width dimensions and with larger center spaces 172 than unit cells 171u located at the left and right side portions 170r, 170l.

FIG. 27 illustrates a greater density of unit cells 171u at a medial portion 170m of the grid reflector 170 relative to the unit cells 171u at right and/or left side portions 170r, 170l. FIG. 27 also illustrates that unit cells 171 located at right and left side portions 170r, 170l can have a larger surface area, height and/or width, shown as a common height and larger width with larger center spaces 172 than unit cells 171 located at the medial portion 170m.

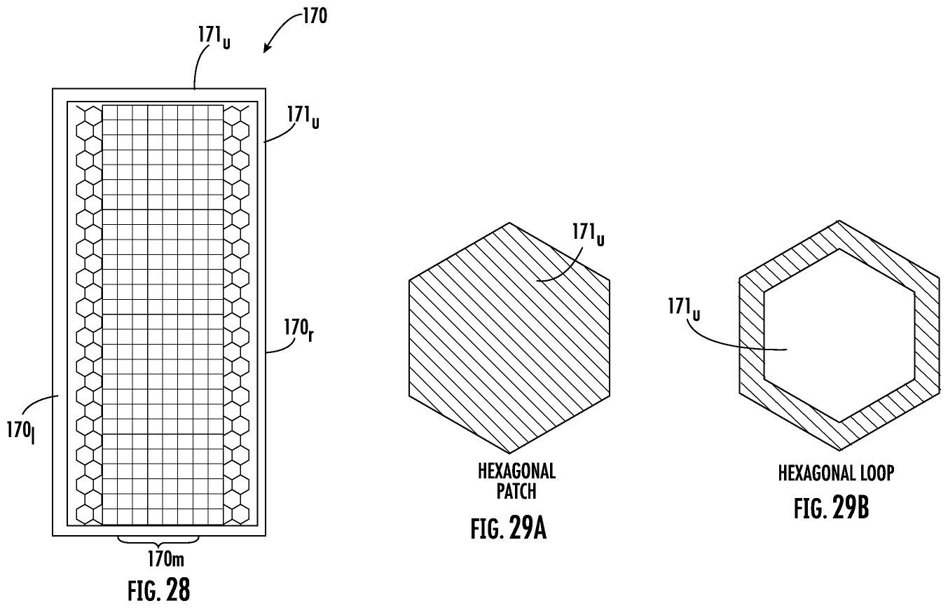

FIG. 28 shows the frequency selective surface of the grid reflector 170 can have different shaped unit cells 171u in different areas. In some embodiments, the medial portion 170m of the grid reflector 170 can comprise square shaped unit cells 171u while right and left sides 170r, 170l, respectively, can have hexagonal shaped unit cells 171u. These different shaped unit cells 171u can be provided on one grid reflector or on first and second grid reflectors 170₁, 170₂, stacked in a front to back (Z) direction. FIG. 29A shows that the hexagonal shape for the unit cell 171u can be a solid (metal) patch while FIG. 29B shows that the hexagonal shape for the unit cell 171u can be provided as a hexagonal loop surrounding an open center or a center of different (non-conductive) material.

Thus, as shown in FIGS. 26, 27 and 28, the first grid reflector 1701 can have an array of unit cells 171 with a first subset of the unit cells 171u tuned for blocking and/or reflecting RF energy in a first frequency band while allowing RF energy in a second frequency band to propagate therethrough and a second subset of the unit cells 171u tuned for blocking and/or reflecting RF energy in the first frequency band and RF energy in a third frequency band. The third frequency band comprises frequencies between the first and second frequency bands.

The first subset 171a of the unit cells 171u can be positioned at an upper portion of the base station antenna 100. The second subset 171b of the unit cells 171u can include unit cells that are below and/or to right and left sides of the first subset 171a of the unit cells 171u.

The first subset 171a of the unit cells 171 can reside behind low band radiating elements 222 and in front of high band radiating elements 1195 (e.g., a mMIMO array) and/or dual band radiating elements. The second subset 171b of the unit cells 171 can reside behind mid-band 232 radiating elements. The first frequency band can be low band, the second frequency band can be a high band frequency band, the third frequency band can be mid-band with at least some frequencies between the first and second frequencies.

The first subset of the unit cells 171u can be positioned at an upper portion of the base station antenna 100. The second subset 171b of the unit cells 171 can include unit cells that are below and/or to right and left sides of the first subset 171a of the unit cells 171. Some of the unit cells 171u in the second subset 171b of the unit cells 171 can be to the left side and/or right side of the first subset of the unit cells 171a.

The first subset 171a of the unit cells 171 can reside behind low band radiating elements 222 and in front of high band radiating elements 1195 (e.g., a mMIMO array). The second subset 171b of the unit cells 171 can reside behind mid-band 232 radiating elements.

The first FSS layer/first grid reflector 1701 can be configured to merge into or attach to longitudinally extending right and left side 214s of (substantially solid) surfaces of the primary reflector 214 at one or more locations, such as along longitudinally extending outer sides. As discussed above, the grid reflector 170 can be configured to have different unit cell configurations and/or sizes at different locations.

In some embodiments, the first FSS layer/first grid reflector 1701 of the passive antenna assembly 190 can be configured to act like a High Pass Filter essentially allowing low band energy to completely reflect as the grid is formed by a sheet of metal while allowing higher band energy, for example, about 3.5 GHz or greater, to pass through, typically substantially completely pass through.

The first and second FSS layers 170₁, 170₂ can be transparent or invisible to the higher band energy and can cooperate to provide a suitable out of band rejection response can be achieved.

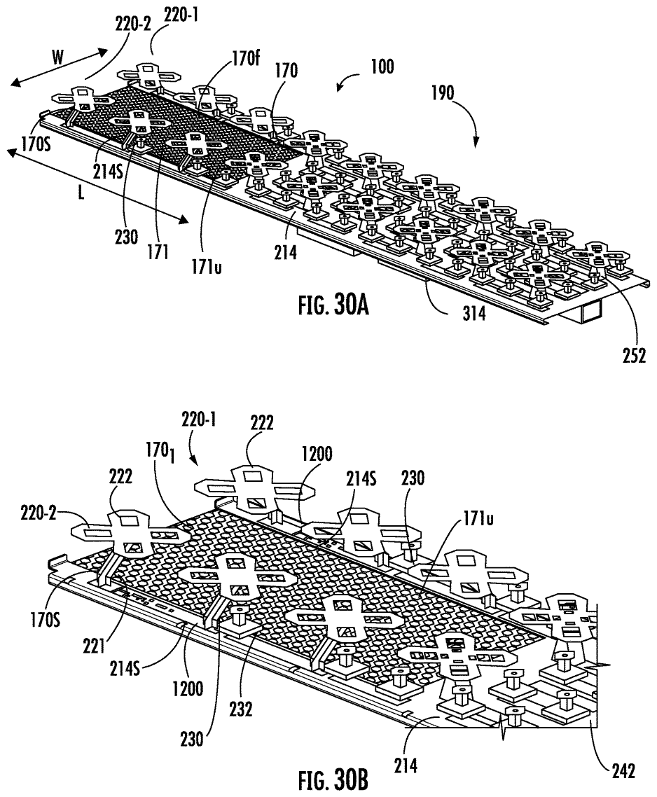

Turning now to FIGS. 30A, 30B, an example passive antenna assembly 190 is shown. The first FSS layer/first grid reflector 170₁ can merge into the primary reflector 214 that extends longitudinally and laterally. The primary reflector 214 may have a longitudinal length that is greater than a longitudinal length of the first grid reflector 1701. The primary reflector 214 can have a solid reflection surface for antenna elements residing in front of the primary reflector 214 and may reside over operational components 314, such as filters, tilt adjusters and the like.

The first grid reflector 170₁ can reside a distance in a range of ⅛ wavelength to ¼ wavelength of an operating wavelength behind the low band dipoles 222, in some embodiments. As discussed above, the term “operating wavelength” refers to the wavelength corresponding to the center frequency of the operating frequency band of the radiating element, e.g., a low band radiating element 222. The first grid reflector 170₁ can reside a distance in a range of 1/10 wavelength to ½ wavelength of an operating wavelength in front of the high band radiating elements 1195, in some embodiments. By way of example, in some particular embodiments, the first grid reflector 170₁ can reside a physical distance of 0.25 inches and 2 inches from a ground plane or reflector 1172 that is behind a mMIMO array of radiating elements 1195 of an active antenna module 110 (FIGS. 31A, 31B). Other placement positions may be used.

In some embodiments, the ground plane or reflector 1172 of the active antenna module 110 can be electrically coupled to the first grid reflector 1701 and/or primary reflector 214 of the base station antenna 100, such as galvanically and/or capacitively coupled. In other embodiments, the ground plane or reflector 1172 of the active antenna module 110 is not electrically coupled to the first grid reflector 170₁ and/or primary reflector 214.

Referring to FIG. 30A, the first grid reflector 1701 can have a longitudinal extent “L” and a lateral extent “W”. The longitudinal extent L can extend a distance that is greater than the lateral extent W. The longitudinal extent L can be less than the lateral extent W. The first grid reflector 170₁ has a front side 170f that faces the front side 100f of the housing 100h/radome 111.

The antenna assembly 190 comprises multiple arrays of radiating elements, typically provided in six columns, with radiating elements that extend forwardly from the front side 170f of the first FSS layer 170₁, with some columns of radiating elements continuing to extend in front of the primary reflector 214. The arrays of radiating elements of the antenna assembly 190 may comprise radiating elements 222 that are configured to operate in a first frequency band and radiating elements 232 that are configured to operate in a second frequency band. Other arrays of radiating elements may comprise radiating elements that are configured to operate in either the second frequency band or in a third frequency band. The first, second and third frequency bands may be different frequency bands (although potentially overlapping). In some embodiments, low band antenna element 222 with dipole arms can reside in front of the grid reflector 170, typically along right and left side portions 170s of the grid reflector 170 and/or primary reflector sides 214s.

The first FSS layer/grid reflector 170₁ and the primary reflector 214 can be monolithically formed as a unitary (sheet) metal body in some embodiments. Alternatively, the first grid reflector 1701 and the primary reflector 214 can be provided as separate components that are directly or indirectly attached and electrically coupled together to provide a common electrical ground. The first grid reflector 1701 and the primary reflector 214 can both be sheet metal of the same or different thicknesses. The first grid reflector 170₁ can be provided as a printed circuit on a dielectric substrate and the primary reflector 214 can be sheet metal.

In some embodiments, the first and second FSS layers 170₁, 170₂ can each be provided as a printed circuit board with conductive traces forming the array of unit cells 171. The first and/or second grid reflector 170₁, 170₂ can be provided as a flex circuit board with the unit cells 171u. The first and second grid reflectors 1701, 1702 can be provided as a non-metallic substrate with metallized traces forming the unit cells 171u.

Some of the radiating elements (discussed below) of the antenna 100 may be mounted to extend forwardly from the main reflector 214, and, if dipole-based radiating elements are used, the dipole radiators of these radiating elements may be mounted approximately ¼ of a wavelength of the operating frequency for each radiating element forwardly of the main reflector 214. The main reflector 214 may serve as a reflector and as a ground plane for the radiating elements of the base station antenna 100 that are mounted thereon.

Still referring to FIGS. 30A, 30B, the passive antenna assembly 190 of the base station antenna 100 can include one or more arrays 220 of low-band radiating elements 222, one or more arrays 230 of first mid-band radiating elements 232, one or more arrays 240 of second mid-band radiating elements 242 and optionally one or more arrays 250 of high-band radiating elements 252. The radiating elements 222, 232, 242, 252, 1195 may each be dual-polarized radiating elements. Further details of radiating elements can be found in WO2019/236203 and WO2020/072880, the contents of which are hereby incorporated by reference as if recited in full herein. Some of the high band radiating elements, such as radiating elements 1195, can be provided as a mMIMO antenna array and may be provided in the active antenna module 110 rather than in the housing 100h of the base station antenna 100.

The low-band radiating elements 222 can be mounted to extend forwardly from the main or primary reflector 214 and the first FSS layer 170₁ and can be mounted in two columns to form two linear arrays 220 of low-band radiating elements 222. Each low-band linear array 220 may extend along substantially the full length of the antenna 100 in some embodiments.

The low-band radiating elements 222 may be configured to transmit and receive signals in a first frequency band. In some embodiments, the first frequency band may comprise the 617-960 MHz frequency range or a portion thereof (e.g., the 617-896 MHz frequency band, the 696-960 MHz frequency band, etc.). The low-band linear arrays 220 may or may not be used to transmit and receive signals in the same portion of the first frequency band. For example, in one embodiment, the low-band radiating elements 222 in a first linear array 220 may be used to transmit and receive signals in the 700 MHz frequency band and the low-band radiating elements 222 in a second linear array 220 may be used to transmit and receive signals in the 800 MHz frequency band. In other embodiments, the low-band radiating elements 222 in both the first and second linear arrays 220-1, 220-2 may be used to transmit and receive signals in the 700 MHz (or 800 MHZ) frequency band.

The first mid-band radiating elements 232 may likewise be mounted to extend forwardly from the main reflector 214 and/or the first FSS layer 1701 and may be mounted in columns to form linear arrays 230 of first mid-band radiating elements 232. The linear arrays 230 of mid-band radiating elements 232 may extend along the respective side edges of the first FSS layer 170₁ and/or the main reflector 214. The first mid-band radiating elements 232 may be configured to transmit and receive signals in a second frequency band. In some embodiments, the second frequency band may comprise the 1427-2690 MHz frequency range or a portion thereof (e.g., the 1710-2200 MHz frequency band, the 2300-2690 MHz frequency band, etc.). In the depicted embodiment, the first mid-band radiating elements 232 are configured to transmit and receive signals in the lower portion of the second frequency band (e.g., some or all of the 1427-2200 MHz frequency band). The linear arrays 230 of first mid-band radiating elements 232 may be configured to transmit and receive signals in the same portion of the second frequency band or in different portions of the second frequency band.

Second mid-band radiating elements 242 can be mounted in columns to form linear arrays of second mid-band radiating elements 242. The second mid-band radiating elements 242 may be configured to transmit and receive signals in the second frequency band. In the depicted embodiment, the second mid-band radiating elements 242 are configured to transmit and receive signals in an upper portion of the second frequency band (e.g., some, or all, of the 2300-2700 MHz frequency band). In the depicted embodiment, the second mid-band radiating elements 242 may have a different design than the first mid-band radiating elements 232.

The high-band radiating elements 252 and/or 1195 can be mounted in columns in the upper medial or center portion of antenna 100 to form a multi-column (e.g., four or eight column) array 250 of high-band radiating elements 252 and/or 1195. The high-band radiating elements 1195 may be configured to transmit and receive signals in a third frequency band. In some embodiments, the third frequency band may comprise the 3300-4200 MHz frequency range or a portion thereof.

In the depicted embodiment, the arrays 220 of low-band radiating elements 222, the arrays 230 of first mid-band radiating elements 232, and the arrays of second mid-band radiating elements 242 are all part of the passive antenna assembly 190, while the array 250 of high-band radiating elements 1195 are part of the active antenna module 110. It will be appreciated that the types of arrays included in the passive antenna assembly 190, and/or the active antenna module 110 may be varied in other embodiments.

It will also be appreciated that the number of linear arrays of low-band, mid-band and high-band radiating elements may be varied from what is shown in the figures. For example, the number of linear arrays of each type of radiating elements may be varied from what is shown, some types of linear arrays may be omitted and/or other types of arrays may be added, the number of radiating elements per array may be varied from what is shown, and/or the arrays may be arranged differently. As one specific example, two linear arrays of second mid-band radiating elements 242 may be replaced with four linear arrays of ultra-high-band radiating elements that transmit and receive signals in a 5 GHz frequency band.

At least some of the low-band and mid-band radiating elements 222, 232, 242 may each be mounted to extend forwardly of and/or from the first FSS layer 170₁ or the main reflector 214.

Each array 220 of low-band radiating elements 222 may be used to form a pair of antenna beams, namely an antenna beam for each of the two polarizations at which the dual-polarized radiating elements are designed to transmit and receive RF signals. Likewise, each array 232 of first mid-band radiating elements 232, and each array of second mid-band radiating elements 242 may be configured to form a pair of antenna beams, namely an antenna beam for each of the two polarizations at which the dual-polarized radiating elements are designed to transmit and receive RF signals. Each linear array may be configured to provide service to a sector of a base station. For example, each linear array 220, 230, may be configured to provide coverage to approximately 120° in the azimuth plane so that the base station antenna 100 may act as a sector antenna for a three-sector base station. Of course, it will be appreciated that the linear arrays may be configured to provide coverage over different azimuth beamwidths. While all of the radiating elements 222, 232, 242, 252, 1195 can be dual-polarized radiating elements in the depicted embodiments, it will be appreciated that in other embodiments some or all of the dual-polarized radiating elements may be replaced with single-polarized radiating elements. It will also be appreciated that while the radiating elements are illustrated as dipole radiating elements in the depicted embodiment, other types of radiating elements such as, for example, patch radiating elements may be used in other embodiments.

Some or all of the radiating elements 222, 232, 242, 252, 1195 may be mounted on feed boards that couple RF signals to and from the individual radiating elements 222, 232, 242, 252, 1195, with one or more radiating elements 222, 232, 242, 252, 1195 mounted on each feed board. Cables (not shown) and/or connectors may be used to connect each feed board to other components of the antenna 100 such as diplexers, phase shifters, calibration boards or the like.

RF connectors or “ports” 140 (FIG. 2A) can be mounted in the bottom end cap 130 that are used to couple RF signals from external remote radio units (not shown) to the arrays of the passive antenna assembly 190. Two RF ports can be provided for each array namely a first RF port 140 that couples first polarization RF signals between the remote radio unit and the array and a second RF port 140 that couples second polarization RF signals between the remote radio unit and the array. As the radiating elements 222, 232, 242 can be slant cross-dipole radiating elements, the first and second polarizations may be a −45° polarization and a +45° polarization.

A phase shifter may be connected to a respective one of the RF ports 140. The phase shifters may be implemented as, for example, wiper arc phase shifters such as the phase shifters disclosed in U.S. Pat. No. 7,907,096 to Timofeev, the disclosure of which is hereby incorporated herein in its entirety. A mechanical linkage may be coupled to a RET actuator (not shown). The RET actuator may apply a force to the mechanical linkage which in turn adjusts a moveable element on the phase shifter in order to electronically adjust the downtilt angles of antenna beams that are generated by the one or more of the low-band or mid-band linear arrays.

It should be noted that a multi-connector RF port (also referred to as a “cluster” connector) can be used as opposed to individual RF ports 140. Suitable cluster connectors are disclosed in U.S. patent application Ser. No. 16/375,530, filed Apr. 4, 2019, the entire content of which is incorporated herein by reference.

The radiating elements 220 can be dipole elements configured to operate in some or all the 617-960 MHz frequency band. A feed circuit comprising a hook balun can be provided on the feed stalk 221 (FIG. 30B). Further discussions of example antenna elements including antenna elements comprising feed stalks can be found in U.S. patent application Ser. No. 17/205,122, the contents of which are hereby incorporated by reference as if recited in full herein.

Turning now to FIGS. 31A, 31B, an example active antenna module 110 is shown. The active antenna module 110 can include an RRU (remote radio unit) unit 1120 with radio circuitry. The active antenna module 110 can also include a filter and calibration printed circuit board assembly (not shown) and an antenna assembly 1190 comprising a reflector or ground plane of a printed circuit board 1172 behind radiating elements 1195. The antenna assembly 1190 may also include phase shifters (not shown), which may alternatively be part of the filter and calibration assembly. The radiating elements 1195 can be provided as a massive MIMO array. The RRU unit 1120 is a radio unit that typically includes radio circuitry that converts base station digital transmission to analog RF signals and vice versa. One or more of the radio unit or RRU unit 1120, the antenna assembly 1190 or the filter and calibration assembly can be provided as separate sub-units that are attachable (stackable). The RRU unit 1120 and the antenna assembly 1190 can be provided as an integrated unit, optionally also including the calibration assembly 1180. Where configured as sub-units, different sub-units can be provided by OEMs or cellular service providers while still using a common base station antenna housing 100h and passive antenna assembly 190 thereof. In other embodiments, the radio circuitry can be provided with the antenna assembly as a single integrated unit.

FIG. 31A illustrates that the rear 100r of the base station antenna 100 can have a flat surface and the active antenna assembly 1190 can be configured to face the rear 100r with the radomes 119, 100r therebetween and with the first and second FSS layers 170₁, 170₂ in front of the radiating elements 1195. FIG. 21B illustrates that the rear 100r of the base station antenna 100 can have recessed segment 102 and sized to receive the radome 119 of the active antenna unit 110, again with the radiating elements 1195 behind and facing the FSS layers 170₁, 170₂.

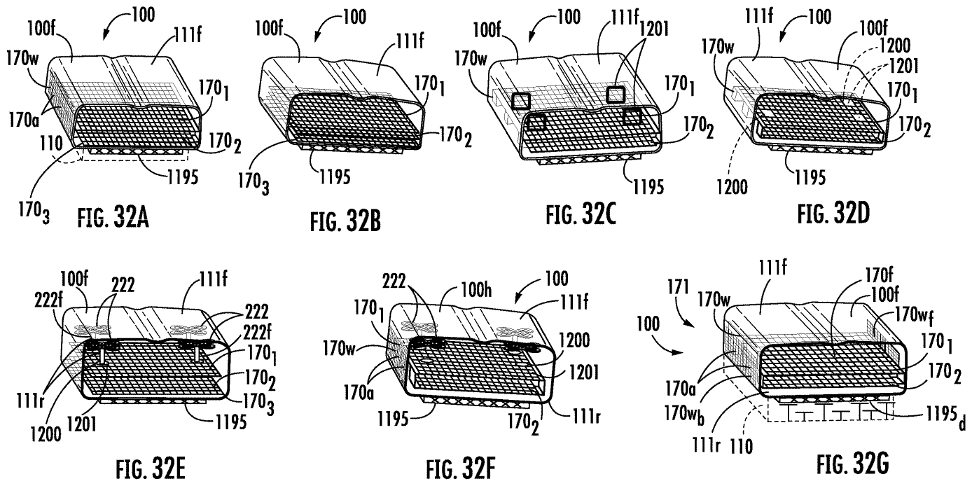

FIGS. 32A-32F illustrate additional example embodiments of stacked FSS layers 170₁, 170₂, spaced apart in a front to back direction of the base station antenna 100. An array of radiating elements 1195 can be positioned behind the first and second FSS layers 170₁, 1702, typically in an active antenna module 110. The array of radiating elements 1195 can comprise a mMIMO array of radiating elements as discussed hereinabove.

The array of radiating elements can be provided as dual band radiating elements 1195d with a first column of radiating elements in a first column projecting forward a first distance and operating in a first band and a second column of radiating elements in a second column, projecting forward a lesser distance than the first column, and operating in a second band and the unit cells in front of the first column can have a different configuration then the unit cells in front of the second column of radiating elements (FIG. 32G).

Referring to FIGS. 32C, 32D, 32E and 32F, the first FSS layer 1701 can include a plurality of spaced apart cutouts 1201. Feed boards 1200 can extend across/along these cutouts 1201 and feed stalks 222f can connect a radiating element 222 to a feed board 1200. The feed boards 1200 can reside behind the primary front surface 170f of the reflector 170₁, in some embodiments and can comprise a conductive (e.g., copper ground plane patterned surface/circuit). The radiating elements 222 can be provided in different configurations and are not limited to the configurations shown.

FIGS. 32A, 32F, 32G illustrate that at least one of the first and second FSS layers 170₁, 170₂ can have a forwardly and/or rearwardly extending portion with unit cells 171u defining at least a portion of a side wall 170w. A respective side wall 170w can be metal or provided as a printed circuit board or combinations thereof. The side walls 170w can be a bent portion of one or more of the first and second FSS layers 170₁, 170₂. The side walls 170w can provide structural support for the reflector(s) 170 and/or radiating elements 222 mounted thereto. The side walls 170w may also or alternatively be configured to improve a radiation pattern provided by one or more of the radiating elements 222 and/or radiating elements 1195 in front of and/or behind the reflector(s) 170₁, 170₂.

The first/front FSS layer 170₁ can be at a common plane with the primary reflector 214 (a front to back position that is aligned with the primary reflector 214).

One or both of the first and second FSS layers 170₁, 170₂ can be configured so that the grid pattern extends across an entire lateral extent thereof. In other embodiments, the grid pattern may/array terminate at feed boards 1200 or solid metal surfaces thereof or coupled thereto.

FIGS. 32B, 32E illustrate that the first and second FSS layers 170₁, 170₂ can be provided without a bent side. One or both of the FSS layers 170₁, 170₂ can couple to internal mounting structures such as laterally extending and/or longitudinally rails to position them in alignment and in position in the base station antenna 100, for example. One or both of the first and second FSS layers 170₁, 170₂ can be coupled to a radome or surface of a housing provided by the base station antenna 100.

Referring to FIGS. 32A, 32F, and 32G, the side walls 170w may be solid metal (e.g., solid sheet metal) or may have apertures 170a or cutouts extending between strip segments extending rearward and/or forward of the front primary surface 170f of the grid reflector 170.

As is also shown in FIG. 32G, the side walls 170w can extend both forwardly and rearwardly of the front surface 170f of the first and/or second FSS layers 170₁, 170₂, shown as extending forwardly and rearwardly of the front/first FSS layer 170₁, orthogonal thereto.

At least part of the side walls 170w can be provided by a metal grid or otherwise configured to provide an isolation surface/wall or an FSS, e.g., metal, metallized, or provided as a frequency selective surface/substrate.

As shown in FIG. 32G, the side wall(s) 170w can have a front segment 170wf that extends forward of the front of the reflector 170f. The side wall(s) 170w can also have a rear/back segment 170wb that extends behind the front segment with the front of the reflector extending laterally therebetween. The front segment 170wf can have a different configuration from the back segment 170wb. The front segment 170wf can be solid metal or formed of an FSS, in some embodiments. The rear/back segment 170wb can be solid, have apertures 170a and/or a grid pattern 171.

FIGS. 32A, 32B and 32E show the base station antenna 100 comprising three stacked FSS layers, 170₁, 170₂, 170₃.

The first and second FSS layers 170₁,170₂ can be spaced apart a distance “h” defined by a front to back dimension. The distance “h” can be in a range of 5-50 mm, such as about 20 mm, in some embodiments.

The distance “h” can correspond to a distance that is equivalent to 0.05-0.5 wavelength of a highest operating wavelength of radiating elements in front or behind one or both of the FSS layers 170₁,170₂.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.) Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The term “about” used with respect to a number refers to a variation of +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
a first frequency selective surface (FSS) comprising a first array of unit cells; and
a second FSS comprising a second array of unit cells,
wherein the first FSS is stacked in front of the second FSS in the base station antenna in a Z direction, wherein each unit cell of the first array of unit cells and each unit cell of the second array of unit cells comprise a plurality of spaced apart inductor structures, and wherein a first unit cell of the first array of unit cells is aligned in an X-Y direction with a first unit cell of the second array of unit cells whereby respective inductor structures of the first unit cell are aligned with respective inductor structures of the first unit cell of the second array of unit cells.

2. The base station antenna of claim 1, wherein the first unit cell of the first array of unit cells comprises a perimeter with first and second neighboring unit cells sharing a perimeter side, and wherein the inductor structures of the first and second neighboring unit cells are electrically connected.

3. (canceled)

4. The base station antenna of claim 1, wherein the first unit cell of the first and second arrays of unit cells each comprise a center and four linear segments that project outwardly from the center, wherein the four linear segments are orthogonal to each other, and wherein the four linear segments each merge into at least one inductor structure of respective inductor structures thereof.

5. The base station antenna of claim 4, wherein the respective inductor structures of each unit cell comprise projections that serially project outwardly from opposing sides of a laterally or longitudinally center line of a corresponding linear segment, and wherein the projections of the inductor structures of the first unit cell of the second array extend outside a boundary of the projections of the first unit cell of the first array of unit cells.

6. The base station antenna of claim 1, wherein inductor structures of neighboring unit cells of the first array of unit cells define a parallel inductor circuit.

7. The base station antenna of claim 1, wherein one inductor structure of a first unit cell of the first array of unit cells merges into one inductor structure of a neighboring second unit cell of the first array of unit cells at a shared perimeter side.

8. (canceled)

9. The base station antenna of claim 4, wherein the first unit cell of the first and second arrays of unit cells further comprises a curvilinear segment that surrounds the center, and wherein the four linear segments extend from four sides of the curvilinear segment that surrounds the center.

10. The base station antenna of claim 4, wherein the four linear segments are inner linear segments, wherein the first unit cell further comprises four outer linear segments, and wherein one inductor structure of the inductor structures resides between a pair of outer and inner linear segments.

11-16. (canceled)

17. The base station antenna of claim 1, wherein the first FSS comprises a first subset of the first array of unit cells configured for blocking and/or reflecting RF energy in a first frequency band while allowing RF energy in a second frequency band to propagate therethrough, wherein the first FSS comprises a second subset of the first array of unit cells configured for blocking and/or reflecting RF energy in the first frequency band and RF energy in a third frequency band, and wherein the third frequency band comprises frequencies between the first and second frequency bands.

18. The base station antenna of claim 17, wherein the first subset of the first array of unit cells are positioned at an upper portion of the base station antenna, and wherein the second subset of the first array of unit cells comprise unit cells that are to the right side of the first subset of the unit cells and also comprises unit cells that are to the left side of the first subset of the unit cells.

19-20. (canceled)

21. The base station antenna of claim 13, wherein the second plurality of radiating elements are provided as a multiple column array in an active antenna module.

22. (canceled)

23. The base station antenna of claim 1, wherein at least some unit cells of the first array of unit cells and/or the second array of unit cells comprise at least one transmission line (TX) segment configured to electrically couple to at least one inductor structure, wherein a length of the at least one TX line segment is configured so that radiofrequency signals from radiating elements traversing the at least one TX line segment undergo a 180 degree phase shift at a defined frequency.

24. The base station antenna of claim 22, wherein a length of the at least one TX line segment is about a half wavelength of a defined frequency response point.

25. A base station antenna, comprising:
a first frequency selective surface (FSS) comprising a first array of unit cells; and
a second FSS comprising a second array of unit cells,
wherein the first FSS is stacked in front of the second FSS in the base station antenna in a Z direction, wherein at least some unit cells of the first array of unit cells and the second array of unit cells are configured to provide an equivalent circuit comprising at least one inductor and at least one transmission line (TX) segment configured to electrically couple to at least one inductor.

26. The base station antenna of claim 25, wherein a length of the at least one TX line segment is configured so that radiofrequency signals from radiating elements traversing the at least one TX line segment undergo a 180 degree phase shift at a defined frequency.

27. The base station antenna of claim 25, wherein a length of the at least one TX line segment is about a half wavelength of a defined frequency response point.

28. (canceled)

29. The base station antenna of claim 25, wherein a first unit cell of the first array of unit cells is electrically coupled to a first unit cell of the second array of unit cells whereby the first unit cells cooperate to define an equivalent circuit to reject or block radiofrequency signals from radiating elements in a first frequency band and pass signals from radiating elements operating in a second frequency band.

30. A grid reflector for a base station antenna, comprising:
a frequency selective surface (FSS) comprising an array of unit cells; and
wherein at least some unit cells of the array of unit cells comprise at least one transmission line (TX) segment.

31. The grid reflector of claim 30, wherein the at least one TX line segment has a length that is about a half wavelength of a defined frequency response point f2.

32. The grid reflector of claim 30, wherein the at least one TX line segment is configured so that radiofrequency signals from radiating elements traversing the at least one TX line segment undergo a 180-phase shift at a defined frequency.

33-34. (canceled)

35. A grid reflector for a base station antenna, comprising:
a frequency selective surface (FSS) comprising a first array of unit cells having a first configuration and a second array of cells having a second configuration, wherein the first array comprises unit cells having a square shape and the second array comprises unit cells having a hexagonal shape, and wherein the first array extends medially across 30-80 percent of a width of the FSS and the second array is provided in two columns on right and left side portions of the first array.

36. The grid reflector of claim 35, wherein at least some unit cells of the array of unit cells comprise at least one transmission line (TX) segment having a length configured so that radiofrequency signals from radiating elements traversing the at least one TX line segment undergo a 180-degree phase shift at a defined frequency.

37. The grid reflector of claim 35, wherein the FSS is configured to have a response frequency f0 that is about 2.5 GHz and provides a bandpass frequency range and a bandstop frequency range.

38. The grid reflector of claim 35, wherein the at least one TX line segment has a length L that is about half wavelength of a defined frequency response point.

39. The grid reflector of claim 35, wherein the at least one TX line segment comprises adjacent parallel conductive lines.
